(19) United States
(12) Patent Application Publication
(10) Pub. No.: US 2025/0081187 A1
(43) Pub. Date: Mar. 6, 2025

(54) ENHANCED SECONDARY UPLINK (eSUL) MEASUREMENT, MOBILITY, AND ACCESS

(71) Applicant: QUALCOMM Incorporated, San Diego, CA (US)

(72) Inventors: Kazuki TAKEDA, Minato-ku (JP); Jing LEI, San Diego, CA (US); Kianoush HOSSEINI, San Diego, CA (US)

(21) Appl. No.: 18/240,518

(22) Filed: Aug. 31, 2023

(51) Int. Cl. H04W 72/1268; H04L 5/00; H04W 76/20

(52) U.S. Cl. CPC H04W 72/1268; H04L 5/0051; H04W 76/20

(57) ABSTRACT

Scheduling information configured to schedule a secondary uplink on a second cell is received on a first cell. Downlink reference signals (DL RSs) are received on the first cell, or radio resource control (RRC) signaling configuring a third cell is received and the DL RSs are received on the third cell. The secondary uplink is transmitted on the second cell. An apparatus receives RRC signaling configuring a location of DL RSs associated with a secondary uplink. The DL RSs are at least one of: within a first carrier bandwidth or a first bandwidth part (BWP) of the secondary uplink, within a second carrier bandwidth or a second BWP of a second cell configured to the apparatus for a non-secondary uplink, or are not within any cell configured to the apparatus. The apparatus transmits the secondary uplink at a power or with timing control determined with the DL RSs.

### TECHNICAL FIELD

This disclosure relates generally to wireless communication and, more specifically, to enhanced secondary uplink (eSUL) measurement, mobility, and access.

### INTRODUCTION

Uplink carrier aggregation (UL-CA) is one technique that increases the usable uplink bandwidth available to a receiver of a scheduled entity. Supplementary uplink (SUL) is one technique that improves the reliability and range of a receiver of a scheduled entity. The two techniques have similarities and differences. Although UL-CA and SUL are sometimes considered under the umbrella of UL-CA, the two techniques are not complements. The techniques were developed separately and have different frameworks. For example, in UL-CA, a cell may have downlink (DL)-only or DL+UL. In SUL, a cell may have DL-only, DL+UL, or DL+UL+SUL; however, when a cell has UL+SUL only one (the UL or the SUL) may transmit at any given time. Developing a technique that would enable the use of previously conflicting aspects of the frameworks of UL-CA and SUL in one unified framework would be advantageous.

### BRIEF SUMMARY OF SOME EXAMPLES

The systems, methods, and devices of this disclosure each have several innovative aspects, no single one of which is solely responsible for the desirable attributes disclosed herein.

In one example, a method at an apparatus is disclosed. The apparatus may be, for example, a scheduled entity. The method may include receiving, in a downlink on a first cell, scheduling information configured to schedule a secondary uplink on a second cell, different from the first cell; at least one of: receiving downlink reference signals on the first cell, or receiving radio resource control signaling configuring a third cell on which the downlink reference signals are received, the third cell being the same as or different from the first cell, and receiving the downlink reference signals on the third cell; and transmitting the secondary uplink on the second cell.

In another example, an apparatus is disclosed. The apparatus may be, for example, a scheduled entity. The apparatus includes one or more memories; and one or more processors. The one or more processors are configured to, individually or collectively, based at least in part on information stored in the one or more memories: receive, in a downlink on a first cell, scheduling information configured to schedule a secondary uplink on a second cell, different from the first cell; at least one of: receive downlink reference signals on the first cell, or receive radio resource control signaling configuring a third cell on which the downlink reference signals are received, the third cell being the same as or different from the first cell, and receive the downlink reference signals on the third cell; and transmit the secondary uplink on the second cell.

In still another example, a method at an apparatus is disclosed. The apparatus may be, for example, a scheduled entity. The method includes receiving radio resource control signaling configuring a location of downlink reference signals used in association with a secondary uplink, wherein the downlink reference signals are at least one of: within a first carrier bandwidth or a first bandwidth part of the secondary uplink, within a second carrier bandwidth or a second bandwidth part of a second cell configured to the apparatus for a non-secondary uplink, or are not within any cell configured to the apparatus; and transmitting the secondary uplink at a transmit power level or with a timing control determined with the downlink reference signals.

In another example, an apparatus is disclosed. The apparatus may be, for example, a scheduled entity. The apparatus includes one or more memories; and one or more processors. The one or more processors are configured to, individually or collectively, based at least in part on information stored in the one or more memories: receive radio resource control signaling configuring a location of downlink reference signals used in association with a secondary uplink, wherein the downlink reference signals are at least one of: within a first carrier bandwidth or a first bandwidth part of the secondary uplink, within a second carrier bandwidth or a second bandwidth part of a second cell configured to the apparatus for a non-secondary uplink, or are not within any cell configured to the apparatus; and transmit the secondary uplink at a transmit power level or with a timing control determined with the downlink reference signals.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic illustration of an example of a wireless communication system according to some aspects of the disclosure.

FIG. 2 is a schematic illustration of an example of a radio access network according to some aspects of the disclosure.

FIG. 3 is a schematic illustration of an example of a disaggregated base station architecture according to some aspects of the disclosure.

FIG. 4 is an expanded view of an exemplary subframe, showing an orthogonal frequency division multiplexing (OFDM) resource grid according to some aspects of the disclosure.

FIG. 5A is an illustration depicting representations of a scheduled entity and a scheduling entity according to some aspects of the disclosure.

FIG. 5B is an illustration of a first frequency range occupied by a DL and an associated normal uplink (NUL) (i.e., a non-SUL uplink) and a second frequency range occupied by an SUL (or an enhanced SUL) according to some aspects of the disclosure.

FIG. 6A is a depiction of a first exemplary configuration of a first cell having a DL and an associated NUL and a second cell having an enhanced SUL (eSUL) according to some aspects of the disclosure.

FIG. 6B is a depiction of a second configuration of a given cell having a DL, an associated NUL, and an associated eSUL according to some aspects of the disclosure.

FIG. 7 is a depiction of a first exemplary configuration of a first cell having a DL and an associated NUL and a second cell having an eSUL according to some aspects of the disclosure.

FIG. 8 is a depiction of a second exemplary configuration of a first cell having a DL and an associated NUL and a second cell having an eSUL according to some aspects of the disclosure.

FIG. 9 is an illustration depicting two eSUL use cases according to some aspects of the disclosure.

FIG. 10 is an illustration depicting three use cases of associations between DL reference signals (RSs) and an eSUL cell according to some aspects of the disclosure.

FIG. 11 depicts a scheduled entity that monitors DL RSs for eSUL on a configured carrier or frequency according to some aspects of the disclosure.

FIG. 12 depicts a scheduled entity that monitors DL RSs for eSUL on a configured carrier or frequency according to some aspects of the disclosure.

FIG. 13 is a block diagram illustrating an example of a hardware implementation of an apparatus employing one or more processing systems according to some aspects of the disclosure.

FIG. 14 is a flow chart illustrating an example process of wireless communication at an apparatus according to some aspects of the disclosure.

FIG. 15 is a flow chart illustrating an example process of wireless communication at an apparatus according to some aspects of the disclosure.

FIG. 16 is a block diagram illustrating an example of a hardware implementation of a network entity employing one or more processing systems according to some aspects of the disclosure.

FIG. 17 is a flow chart illustrating an example process of wireless communication at an apparatus according to some aspects of the disclosure.

FIG. 18 is a flow chart illustrating an example process of wireless communication at an apparatus according to some aspects of the disclosure.

Like reference numbers and designations in the various drawings indicate like elements.

### DETAILED DESCRIPTION

The detailed description set forth below in connection with the appended drawings is directed to some particular examples for the purpose of describing innovative aspects of this disclosure. However, a person having ordinary skill in the art will readily recognize that the teachings herein can be applied in a multitude of different ways. Some or all of the described examples may be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system, or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to persons having ordinary skill in the art that these concepts may be practiced without these specific details. In some examples, well-known structures and components are shown in block diagram form in order to avoid obscuring such concepts.

While aspects and examples are described in this application by illustration to some examples, persons having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna. RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

An enhanced SUL (eSUL) framework is described herein that enables aspects of UL-CA with UL cell(s) that do not have a corresponding DL in a cell carrying the eSUL. The eSUL framework also facilitates initial access (e.g., via a random access procedure) using a cell that has a UL but does not have a corresponding DL associated with the UL in the cell.

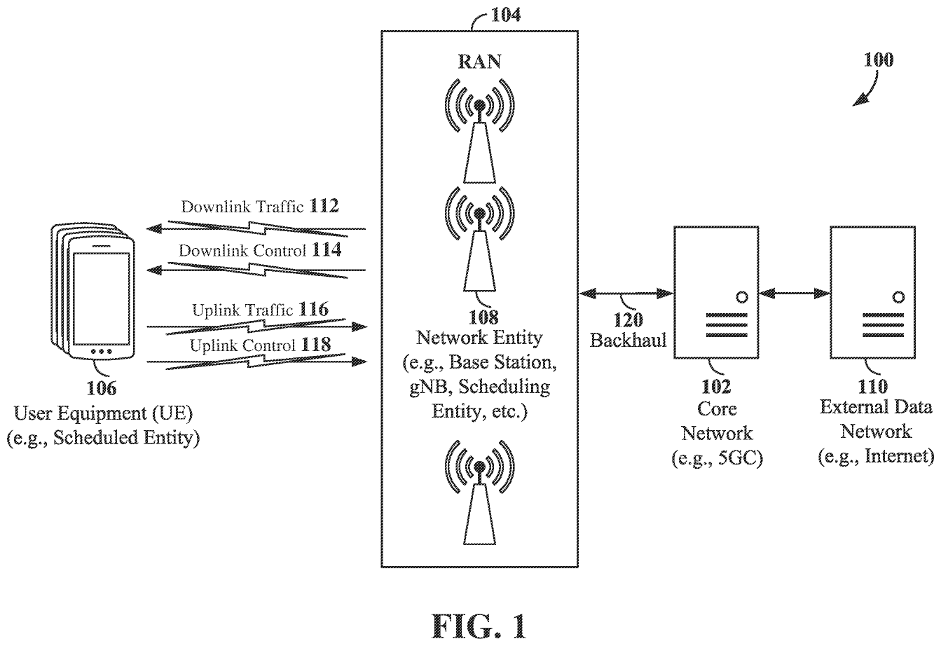

The various concepts presented throughout this disclosure may be implemented across a broad variety of telecommunication systems, network architectures, and communication standards. Referring now to FIG. 1, as an illustrative example without limitation, a schematic illustration of an example of a wireless communication system 100 according to some aspects of the disclosure is presented. The wireless communication system 100 includes three interacting domains: a core network 102, a radio access network (RAN) 104, and a user equipment (UE) 106. By virtue of the wireless communication system 100, the UE 106 (also referred to herein as a wireless communication device) may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities 108. Broadly, a network entity may be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some examples, a network entity may be a network element in a radio access network responsible for radio transmission and reception in one or more cells to or from a UE. In different technologies, standards, or contexts, a network entity may variously be referred to by persons having ordinary skill in the art as a base transceiver station (BTS), a radio base station, a base station, a radio transceiver, a transceiver function, a basic service set (BSS), an extended service set (ESS), an access point (AP), a Node B (NB), an eNode B (eNB), a gNode B (gNB), a transmission and reception point (TRP), a scheduling entity, a network entity, or some other suitable terminology. In some examples, a network entity may include two or more TRPs that may be collocated or non-collocated. Each TRP may communicate on the same or different carrier frequency within the same or different frequency band. In examples where the RAN 104 operates according to both the LTE and 5G NR standards, one of the network entities may be an LTE network entity, while another network entity may be a 5G NR network entity.

The RAN 104 is further illustrated supporting wireless communication for multiple mobile apparatuses. A mobile apparatus may be referred to as user equipment (UE) in 3GPP standards, but may also be referred to by persons having ordinary skill in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, a scheduled entity, or some other suitable terminology. A UE 106 may be an apparatus (e.g., a mobile apparatus, a wireless communication device) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smartphone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smartwatch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data and/or relevant QoS for transport of critical service data.

Wireless communication between the RAN 104 and the UE 106 may be described as utilizing an air interface. Transmissions over the air interface from a network entity (e.g., similar to network entity 108) to one or more UEs (e.g., similar to UE 106) may be referred to as downlink (DL) transmission. In accordance with certain aspects of the present disclosure, the term downlink may refer to a point-to-multipoint transmission or a point-to-point transmission (e.g., groupcast, multicast, or unicast) originating at a network entity (e.g., network entity 108). Another way to describe this scheme may be to use the term broadcast channel multiplexing. Transmissions from a UE (e.g., UE 106) to a network entity (e.g., network entity 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, where a network entity (e.g., a network entity 108) allocates resources for communication among some or all devices and equipment within its service area or cell. Within the present disclosure, as discussed further below, the network entity (e.g., network entity 108) may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the network entity 108.

Network entities 108 are not the only entities that may function as scheduling entities. That is, in some examples, a UE may function as a scheduling entity, scheduling resources for one or more scheduled entities (e.g., one or more other UEs). For example UEs may communicate directly with other UEs in a peer-to-peer or device-to-device fashion and/or in a relay configuration.

As illustrated in FIG. 1, the network entity 108 may broadcast downlink traffic 112 (also referred to as downlink data traffic) to one or more UEs 106. Broadly, the network entity 108 may be a node or device responsible for scheduling traffic (e.g., data traffic, user data traffic) in a wireless communication network, including the downlink traffic 112 and, in some examples, uplink traffic 116 (also referred to as uplink data traffic) from one or more UEs 106 to the network entity 108. On the other hand, the UE 106 (e.g., the scheduled entity) may be a node or device that receives downlink control 114 information, including but not limited to scheduling information (e.g., a grant), synchronization or timing information, or other control information from another entity in the wireless communication network such as the network entity 108. The UE 106 may further transmit uplink control 118 information, including but not limited to a scheduling request or feedback information, or other control information to the network entity 108.

In addition, the uplink control 118 information and/or downlink control 114 information and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, the network entity 108 may include a backhaul interface (not shown) for communication with a backhaul portion 120 of the wireless communication system 100. The backhaul portion 120 may provide a link between a network entity 108 and the core network 102. Further, in some examples, a backhaul network may provide interconnection between respective network entities 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC) or any other suitable standard or configuration.

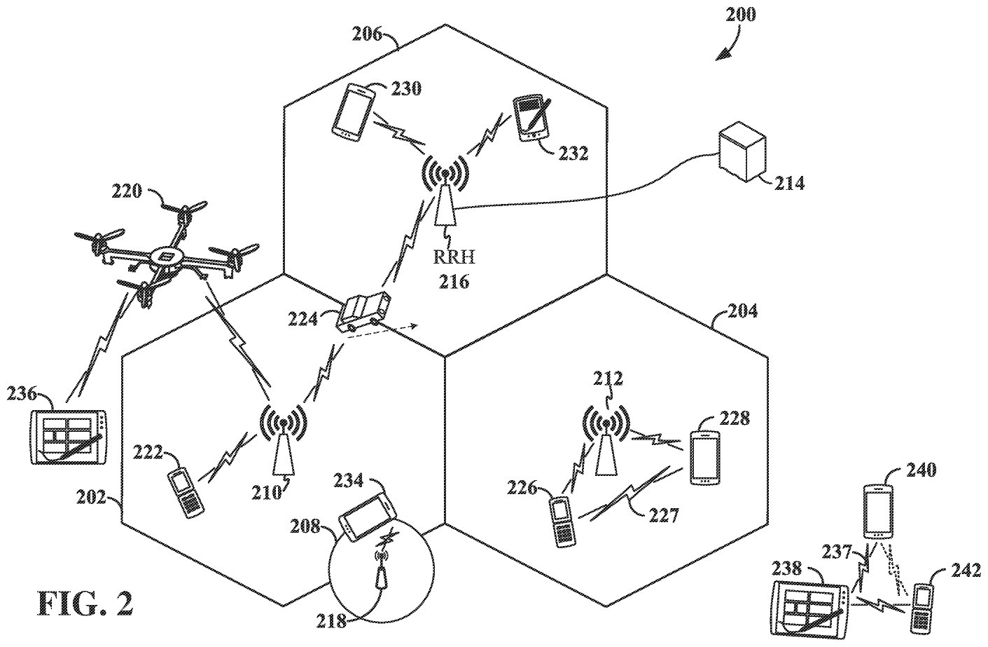

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or network entity. FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas, with each antenna responsible for communication with UEs in a portion of the cell.

Various network entity arrangements can be utilized. For example, in FIG. 2, two network entities, referred to as base station 210 and base station 212, are shown in cells 202 and 204. A third network entity, referred to as base station 214, is shown controlling a remote radio head (RRH) 216 in cell 206. That is, a network entity can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of network entities (e.g., base stations, gNBs, TRPs, scheduling entities) and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the network entity 108 described above and illustrated in FIG. 1.

FIG. 2 further includes an unmanned aerial vehicle (UAV) 220, which may be a drone, quadcopter, octocopter, etc. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example UEs 222 and 224 may be in communication with base station 210. UEs 226 and 228 may be in communication with base station 212, UEs 230 and 232 may be in communication with base station 214 by way of RRH 216. UE 234 may be in communication with base station 218, and UE 236 may be in communication with mobile base station 220. In some examples, the UEs 222, 224, 226, 228, 230, 232, 234, 236, 238, 240, and/or 242 may be the same as or similar to the one or more UEs 106 described above and illustrated in FIG. 1. In some examples, the UAV 220 may be a mobile network entity and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station (e.g., a network entity). In other examples, two or more UEs (e.g., UEs 226 and 228) within the coverage area of a network entity (e.g., base station 212) may also communicate sidelink signals 227 over a direct link (sidelink) without conveying that communication through the network entity (e.g., base station 212). In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error-correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of network entities and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a network entity (e.g., an aggregated or disaggregated base station, gNB, eNB. TRP, scheduling entity, etc.), or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell (e.g., cell 202) to the geographic area corresponding to a neighbor cell (e.g., cell 206). When the signal strength or quality from the neighbor cell exceeds that of its serving cell for a given amount of time, the UE 224 may transmit a reporting message to its serving network entity (e.g., base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, where technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHZ-7.125 GHz) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHZ-71 GHZ), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHZ” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may be within FR2, FR4. FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different subbands of the carrier bandwidth. This type of full-duplex communication may be referred to herein as subband full-duplex (SBFD), also known as flexible duplex.

Deployment of communication systems, such as 5G new radio (NR) systems, may be arranged in multiple manners with various components or constituent parts. In a 5G NR system, or network, a network entity, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS. 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

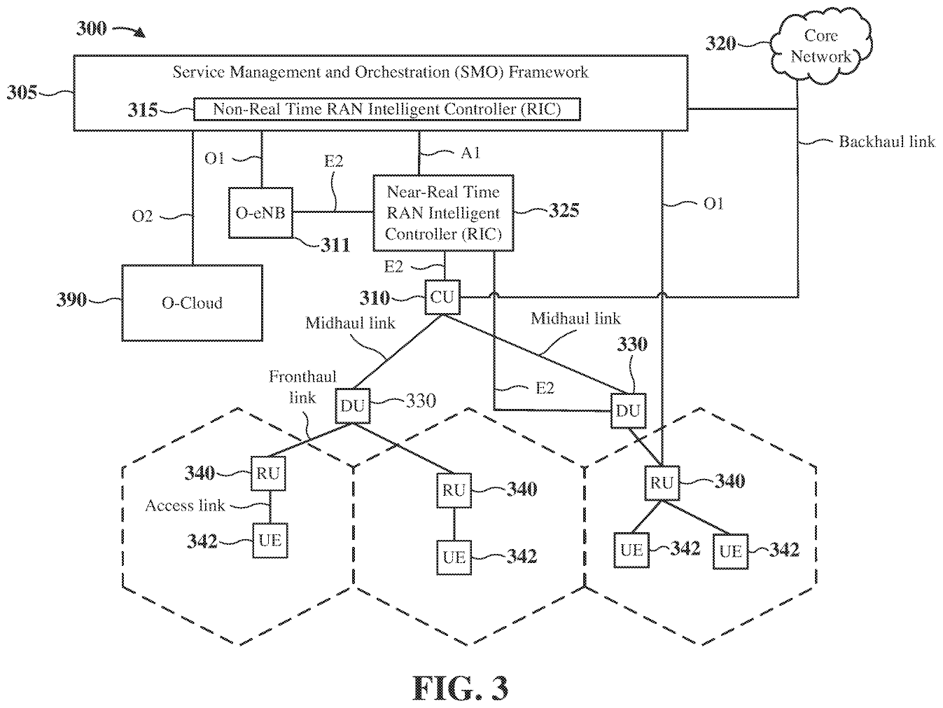

FIG. 3 is a schematic illustration of an example disaggregated base station 300 architecture according to some aspects of the disclosure. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 342 via one or more radio frequency (RF) access links. In some implementations, the UE 342 may be simultaneously served by multiple RUs 340. UE 342 may be the same or similar to any of the UEs or scheduled entities illustrated and described in connection with FIG. 1 and FIG. 2, for example.

Each of the units, i.e., the CUS 310, the DUs 330, the RUs 340, as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter, or a transceiver (such as a radio frequency (RF) transceiver), configured to receive or transmit signals, or both, over a wireless transmission medium to one or more of the other units.

In some aspects, the CU 310 may host one or more higher-layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 342. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 3G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

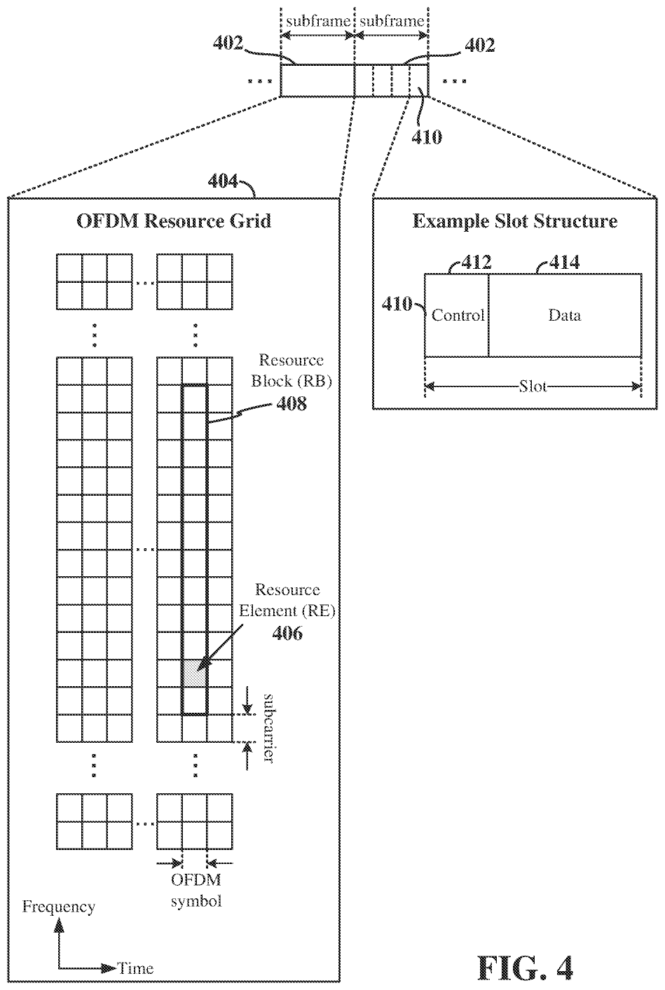

Various aspects of the present disclosure will be described with reference to an OFDM waveform, schematically illustrated in FIG. 4. It should be understood by persons having ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, persons having ordinary skill in the art will readily appreciate, the physical (PHY) transmission structure for any particular application may vary from the example described here, depending on any number of factors. Here, time is depicted in the horizontal direction with units of OFDM symbols; and frequency is depicted in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), subband, or bandwidth part (BWP). A set of subbands or BWPs may span the entire bandwidth. Scheduling of wireless communication devices (e.g., V2X devices, sidelink devices, or other UEs, hereinafter generally referred to as UEs) for downlink, uplink, or sidelink transmissions may involve scheduling one or more resource elements 406 within one or more subbands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., an aggregated or disaggregated base station, gNB, eNB, TRP, scheduling entity, etc.) or may be self-scheduled by a UE/sidelink device implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. An additional example may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of slot 410 illustrates that the slot 410 includes a control region 412 and a data region 414. In general, the control region 412 may carry control channels, and the data region 414 may carry data channels. In some examples, a Uu slot (e.g., slot 410) may contain all DL, all UL, or at least one DL portion and at least one UL portion. The structures illustrated in FIG. 4 are merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the network entity may allocate one or more REs 406 (e.g., within the control region 412) of the slot 410 to carry DL control information including one or more DL control channels, such as a physical downlink control channel (PDCCH), to one or more UEs (e.g., scheduled entities). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to persons having ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) of the Uu slot 410 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 4, 10, 20, 50, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In a UL transmission, the UE (e.g., scheduled entity) may utilize one or more REs 406 of the Uu slot 410 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 406 (e.g., within the data region 414) of the Uu slot 410 may be allocated for data traffic. Such data traffic may be carried on one or more traffic channels, such as, for a DL transmission, a physical downlink shared channel (PDSCH); or for a UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, sidelink MAC-CEs may be transmitted in the data region 414 of the slot 410. In addition, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number (e.g., a quantity) of bits of information, may be a controlled parameter based on the modulation and coding scheme (MCS) and the number of RBs in a given transmission.

The channels or carriers described above in connection with FIGS. 1-4 are not necessarily all of the channels or carriers that may be utilized between devices, and persons of ordinary skill in the art will recognize that other channels or carriers may be utilized in addition to those illustrated, such as other traffic, control, and feedback channels.

Scheduling and scheduled entities may employ various schemes to increase the amounts of data received (by a scheduled entity) in a downlink channel (from a scheduling entity) and transmitted (by a scheduled entity) in an uplink channel (to the scheduling entity). Other schemes may increase uplink channel range (i.e., distance, coverage) and reliability.

A first exemplary scheme may be referred to as carrier aggregation. In carrier aggregation, two or more component carriers (CCs) may be aggregated to increase the overall bandwidth of information available to a scheduled entity. The degree to which a given scheduled entity supports carrier aggregation depends on the capability of the given scheduled entity. Generally, in carrier aggregation, a scheduled entity may simultaneously receive (in downlink) or transmit (in uplink) on one or multiple CCs. For example, a scheduled entity with single timing advance capability for carrier aggregation may simultaneously receive and/or transmit on multiple CCs corresponding to multiple serving cells sharing the same timing advance (i.e., multiple serving cells grouped in one timing advance group (TAG)). In another example, a scheduled entity with multiple timing advance capabilities for carrier aggregation may simultaneously receive and/or transmit on multiple CCs corresponding to multiple serving cells with different timing advances (i.e., multiple serving cells grouped in multiple TAGs). In another example, a non-carrier aggregation capable UE may receive on a single CC and transmit on a single CC corresponding to one serving cell (e.g., one serving cell in one TAG).

A second exemplary scheme may be referred to as supplementary uplink (sometimes referred to as supplemental uplink) and abbreviated using the initials SUL. An SUL may be used with a UL (also referred to as a normal uplink (NUL)) in a NUL/DL carrier pair (FDD band), supplemental downlink (SDL) carrier that does not have UL carrier, or a bidirectional carrier (TDD band). Utilizing SUL, a scheduled entity may be configured with an additional uplink channel (i.e., the SUL channel may be added to the UL, or NUL, channel). The added SUL channel may be used, for example, when a configured uplink channel (or NUL channel) becomes, or starts to become, unreliable. By way of example, the NUL may be at a higher carrier frequency than the SUL. Based in part on its lower frequency, and given the same transmitter power, a first effective range of the NUL may be less than a second effective range of the SUL.

In a case of a mobile scheduled entity, as the separation distance between the scheduling entity and the scheduled entity increases, the error rate of the NUL may increase (e.g., because the received power of the NUL at the scheduling entity decreases as the separation distance increases). At a given instant, the scheduled entity may switch its uplink transmissions from the higher carrier frequency NUL to the lower carrier frequency SUL. Due to the greater effective range of the lower frequency SUL, the error rate of the SUL may be acceptable to the scheduling entity.

SUL differs from carrier aggregation in that the scheduled entity may be scheduled to transmit either on the SUL or the NUL but not on both the SUL and the NUL simultaneously.

A third exemplary scheme may be referred to as transmitter-switching (Tx-Switching). In Tx-switching, in connection with carrier aggregation and/or SUL, a scheduled entity configured with one or multiple uplink transmitters may be configured to dedicate a first of the two uplink transmitters to transmissions on a first carrier (e.g., NR transmissions on the first carrier) while the second of the two uplink transmitters may be configured to dynamically switch between transmissions on the first carrier and transmissions on a second carrier (e.g., NR transmissions on the second carrier). Under some circumstances, dual stream uplink may be facilitated by UL Tx-switching.

Returning to the case of SUL, a scheduled entity may be configured with two uplinks (a normal uplink (NUL) and a supplementary uplink (SUL)) and one downlink on one cell. The network may control the uplink transmissions on the two uplinks to avoid overlapping PUSCH/PUCCH transmissions in time. Overlapping transmissions on PUSCH may be avoided through scheduling. Overlapping transmissions on PUCCH may be avoided through configuration (e.g., the network may configure the PUCCH for either the NUL or the SUL, but not both). In addition, initial access using random access procedures may be supported using the NUL or the SUL (i.e., either one is acceptable).

For example, in a random access procedure in a cell configured with a NUL and an SUL, a network may explicitly signal which carrier to use for the random access procedure (i.e., use either the NUL or the SUL). In cases where the network does not configure the NUL or the SUL for the random access procedure, the scheduled entity may make the selection. In some aspects, the scheduled entity may select the SUL carrier in response to a measured quality of an associated downlink channel being lower than a broadcast threshold. The scheduled entity may select the NUL or the SUL carrier before the scheduled entity selects between a 2-step or a 4-step random access type procedure. A reference signal received power (RSRP) threshold for selecting between the 2-step and 4-step random access type procedures may be configured separately for the NUL and the SUL. According to some aspects, all uplink transmissions associated with the selected 2-step or 4-step random access type procedure remain on the selected one of the NUL or the SUL carrier.

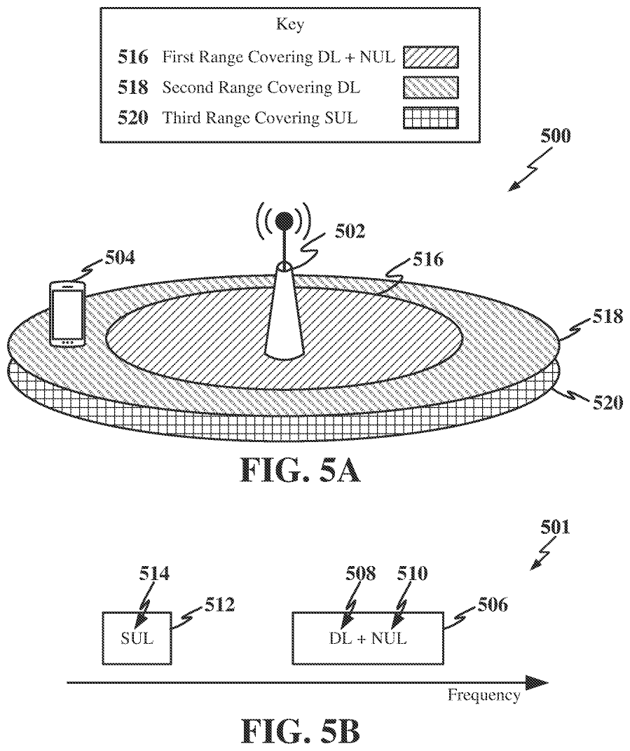

FIG. 5A is an illustration 500 depicting representations of a scheduling entity 502 and a scheduled entity 504 according to some aspects of the disclosure. FIG. 5B is an illustration 501 of a first frequency range 506 occupied by a DL 508 and an associated NUL 510 and a second frequency range 512 (at a lower frequency range than the first frequency range 506) occupied by an SUL 514 (or a secondary uplink also referred to as an enhanced SUL (eSUL)) according to some aspects of the disclosure. The order of the first frequency range 506 and the second frequency range 512 is for ease of explanation and not limitation; in several examples, the first frequency range 506 is higher than the second frequency range 512. The relative dimensions (e.g., width) of the first frequency range 506 and the second frequency range 512 are also presented for ease of illustration and not limitation. The scheduling entity 502 may be the same as, for example, any scheduling entity, eNB, gNB, base station, or network entity as shown and described in connection with FIGS. 1-3. The scheduled entity 504 may be the same as, for example, any user equipment, wireless communication device, or mobile communication device as shown and described in connection with FIGS. 1-3.

In the examples of FIGS. 5A and 5B, the DL 508 and an associated NUL 510 are allocated in one cell to facilitate bidirectional communication between the scheduling entity 502 and the scheduled entity 504. The SUL 514 may also be allocated in the same cell (alternatively, according to aspects described herein, an eSUL may be allocated in a different cell) to facilitate uplink communication from the scheduled entity 504 to the scheduling entity 502.

In SUL, also referred to as legacy SUL herein, a serving cell includes a DL, non-SUL uplink carrier(s) (also referred to as normal uplink (NUL) carriers), and an SUL carrier. In legacy SUL, there is no case where the SUL is not associated with a DL in the same serving cell as the SUL. In legacy SUL, the SUL carrier is co-located with the DL and non-SUL UL carriers in the serving cell. A downlink reference signal (DL RS) used in power/timing control and in UL beam management is common for the SUL and non-SUL carriers of the serving cell. In case TRP-switching is carried out for a serving cell with legacy SUL: the scheduled entity measures DL RSs (e.g., SSBs or CSI-RSs) from multiple cells/TRPs as L3 radio resource management (RRM) and/or L1 beam management/inter-carrier beam management (BM/ICBM) and reports back to the serving cell/TRP; the network may trigger a handover (HO)/lower-layer triggered mobility (LTM) to switch TRPs (or beams) over different cells or indicate a TCI-state to switch TRPs (or beams) in the cell.

Based on the switch, the scheduled entity 504 may change DL RSs for RRM/BM/ICBM and UL power/timing control for SUL/non-SUL carriers. For example, DL RSs from the same TRP are used for UL power/timing control for SUL/non-SUL before/after the switch. The DL and SUL/non-SUL carriers of the same cell are assumed to be co-located. For random access, PRACH can be transmitted in either SUL or non-SUL (because they are co-located).

In general, as depicted in FIG. 5, from the perspective of the scheduling entity 502, a first range 516 within which transmissions from the scheduling entity 502 over the DL 508 are decoded correctly by the scheduled entity 504 and within which transmissions from the scheduled entity 504 over the NUL 510 are decoded correctly by the scheduling entity 502 is represented by a first circle surrounding the scheduling entity 502. However, a transmitter of the scheduling entity 502, transmitting the DL 508, is generally more powerful than a transmitter of the scheduled entity 504, transmitting the NUL 510. Given that the DL 508 and the NUL 510 are relatively near each other in the frequency domain (i.e., they are both in the first frequency range 506), it may be understood that the scheduling entity 502 may transmit the DL 508 over a greater distance than the scheduled entity 504 may transmit the NUL 510. Accordingly, a second range 518, within which transmissions from the scheduling entity 502 over the DL 508 are decoded correctly by the scheduled entity 504, is depicted as a second circle surrounding the scheduling entity 502. Between the circumference of the first circle representing the first range 516 and the circumference of the second circle representing the second range 518, the transmitter of the scheduled entity 504 does not have sufficient power to transmit the NUL 510 such that the NUL 510 would be decoded correctly by the scheduling entity 502.

However, the SUL 514 is transmitted by the scheduled entity 504 in the second frequency range 512, which is lower than the first frequency range 506 associated with both the DL 508 and the NUL 510. For a similar transmitted power, a third range 520, within which transmissions from the scheduled entity 504 over the SUL 514 are decoded correctly by the scheduling entity 502 is represented by a third circle surrounding the scheduling entity 502. The third range 520 is greater than the first range 516. Between the circumference of the first circle representing the first range 516 and the circumference of the third circle representing the third range 520, the transmitter of the scheduled entity 504 has sufficient power to transmit the SUL 514 such that the SUL 514 would be decoded correctly by the scheduling entity 502.

Accordingly, as the scheduled entity 504 moves further from the scheduling entity 502, the NUL 510 may have an increasing bit error rate (or have degradation of the communication channel), and therefore, the scheduled entity 504 may switch its uplink transmissions from the NUL 510 to the SUL 514 to extend the range of the scheduling entity 502 in this example of a power-limited use case.

Although carrier aggregation (CA) and supplementary uplink (SUL) may sometimes be considered under the same umbrella, there are differences between CA and SUL. For example, using CA increases available bandwidth between a scheduling entity and a scheduled entity in both the downlink and uplink directions. Increasing bandwidth may, for example, increase peak data rates. The at least two aggregated carriers utilized in CA may have similar bandwidths and may operate at similar frequencies. Each uplink carrier may operate with one associated downlink carrier, simplifying the support for simultaneous scheduling of multiple uplink transmissions in parallel. Each downlink carrier may be associated with one cell; accordingly, as each downlink is associated with an uplink, multiple uplink carriers in CA correspond to multiple cells.

Unlike CA, where an increase in available bandwidth is enabled, SUL enables a switch from a NUL to an SUL (for example in a power-limited example such as that depicted in FIG. 5). The switch from the NUL (e.g., at higher frequencies) to an SUL (e.g., at lower frequencies) allows a scheduled entity to take advantage of lower path loss at the lower frequencies. Additionally, unlike CA, an SUL carrier does not have its own associated downlink carrier. Instead, one downlink carrier is shared by the NUL and the SUL. Accordingly, in some examples of SUL, a single cell encompasses one downlink carrier and two uplink carriers (the NUL and the SUL carriers).

Although there are some similarities, differences between SUL and uplink-carrier aggregation (UL-CA) make it difficult to enable a framework that treats SUL and UL-CA in a unified manner. Table I below provides a non-limiting example of some similarities and differences between select aspects of SUL and UL-CA.

TABLE 1
Comparison of Select SUL and UL-CA Aspects

| Aspect | SUL | UL-CA |
|---|---|---|
| UL/DL | A cell has DL-only, | A cell has DL-only or DL + |
| Association | DL + UL, or DL + | UL |
| | NUL + SUL | |
| Simultaneous | No | Yes |
| Tx | | |
| UL-Tx | Yes | Yes (“switchedUL” or “dualUL” |
| Switching | | for any UL-CC pair) |
| Scheduling | NUL/SUL indicator in | Carrier indication |
| mechanism | a DCI | field (CIF) in a DCI |
| Multi-cell | No | Yes |
| scheduling | | |
| HARQ space | One HARQ space for | Independent HARQ spaces for |
| | NUL/SUL carriers of a | each component carrier |
| | serving cell | |
| Support of | Yes | No (only on PCell) |
| random access | | |
| for idle mode | | |

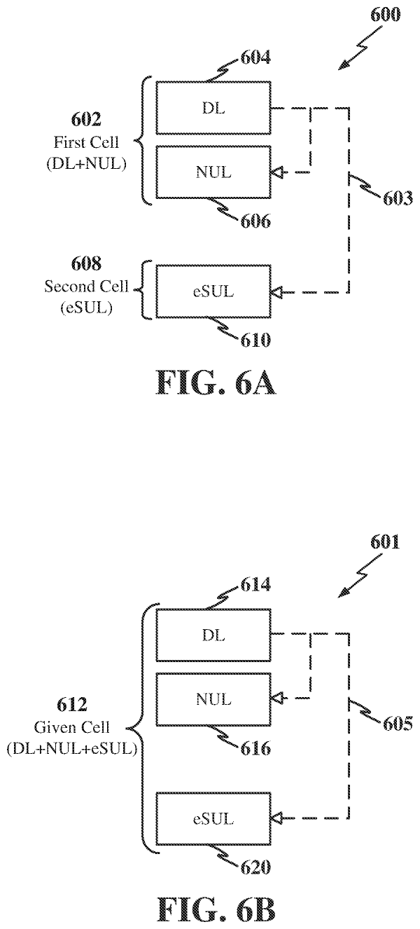

Accordingly, a new type of SUL, referred to herein as a secondary uplink or an enhanced SUL (eSUL), may be described herein to unify the SUL and UL-CA frameworks. Hereinafter, the terms secondary uplink and enhanced SUL (eSUL) may be used synonymously and interchangeably. FIG. 6A is a depiction of an exemplary first configuration 600 of a first cell 602 having a DL 604 and an associated NUL 606 and a second cell 608 having an eSUL 610 according to some aspects of the disclosure. According to the first configuration 600, an eSUL in a given cell has no association with a downlink in the given cell. For example, as depicted in the first configuration 600, the eSUL 610 in the second cell 608 has no associated downlink in the second cell 608. Because the eSUL 610 is not associated with a downlink in the second cell 608, the eSUL 610 may be linked (e.g., associated with) a downlink in another cell. For example, a conceptual linkage 603 (e.g., an association in contrast to an electrical or mechanical coupling) between the DL 604 in the first cell 602, the NUL 606 in the first cell 602, and the eSUL 610 in the second cell 608 may be utilized in connection with scheduling the NUL 606 and the eSUL 610 as well as used in connection with estimations of pathloss and timing in connection with the NUL 606 and eSUL 610. The conceptual linkage 603 (e.g., the association) between the DL 604 and the NUL 606 in the first cell 602 and between the DL 604 and the eSUL 610 in the second cell 608 (and a scheduled entity (not shown)) is represented using dashed lines for ease of illustration and not limitation. In the descriptions included herein, an eSUL in a second cell may be linked/associated with a first DL in a first cell (where the first cell may also carry a NUL) for purposes of exchanging user data between a scheduling entity and a scheduled entity, and the eSUL in the second cell may not be linked/associated with a second DL in the second cell for purposes of exchanging user data between the scheduling entity and the scheduled entity; however, the eSUL in the second cell may be linked/associated with the second DL in a first or another cell (e.g., third cell) for purposes of monitoring DL RSs (e.g., SSBs and/or CSI-RSs) on the second DL in connection with, for example, L3 RRM and/or L1 BM/ICBM and power/timing control for the eSUL in the second cell. An uplink-configuration (UL-Config) for the NUL 606 of the first cell 602 may be included in one or more of: a servingCellConfigCommonSIB; a servingCellConfigCommon; or a servingCellConfig. Similarly, an uplink-configuration (UL-Config) for the eSUL 610 of the second cell 608 may be included in one or more of: a servingCellConfigCommonSIB; a servingCellConfigCommon; or a servingCellConfig.

FIG. 6B is a depiction of a second configuration 601 of a given cell 612 having a DL 614, an associated NUL 616, and an associated eSUL 620 according to some aspects of the disclosure. According to the second configuration 601, the eSUL 620 is one of at least two uplink carriers (e.g., one of at least the NUL 616 and the eSUL 620) associated with the DL 614 in the given cell 612. In other words, according to the second configuration 601, multiple uplink carriers (e.g., the NUL 616 and the eSUL 620) may be associated with the DL 614 in the given cell 612. A conceptual linkage 605 (e.g., an association in contrast to an electrical or mechanical coupling) between the DL 614, the NUL. 616, the eSUL 620 in the given cell 612 and a scheduled entity (not shown) is represented using dashed lines for ease of illustration and not limitation. In some examples, the aspects of being linked or associated may be made with reference to, for example, user data flowing from a scheduling entity (not shown) to the scheduled entity (not shown) in a linked/associated DL and flowing from the scheduled entity to the scheduling entity in a linked/associated NUL and/or eSUL. An uplink-configuration (UL-Config) for the NUL 616 and the eSUL 620 of the given cell 612 may both be included in one or more of: a servingCellConfigCommonSIB; a servingCellConfigCommon; or a servingCellConfig.

As described herein, aspects may enable a unification of SUL and UL-CA under an eSUL framework. For example, described herein may be aspects that may enable UL-CA with eSUL cell(s) that do not have a corresponding DL in the eSUL cell(s) (e.g., as illustrated and described in the example of FIG. 6A). Such eSUL cell(s) may be scheduled by a PDCCH in another cell that has a DL associated with the eSUL cell(s). According to some aspects, at least some legacy cross-carrier/multi-carrier scheduling frameworks may be re-used. The aspects described herein may support simultaneous transmission and UL Tx-switching in connection with the first configuration 600, as shown and described in connection with FIG. 6A and the second configuration 601, as shown and described in connection with FIG. 6B. Both the first configuration 600 and the second configuration 601 may be used with any combination(s) of NUL(s)/eSUL(s) in a UL-CA configuration.

Also described herein may be aspects that may enable initial access (e.g., via a random access procedure) to an eSUL cell that does not have a corresponding DL (e.g., an associated DL) in the eSUL cell. In such aspects, a SIB on a DL in another cell may carry configuration information utilized in connection with a scheduled entity's selection of a NUL or an eSUL for a random access procedure.

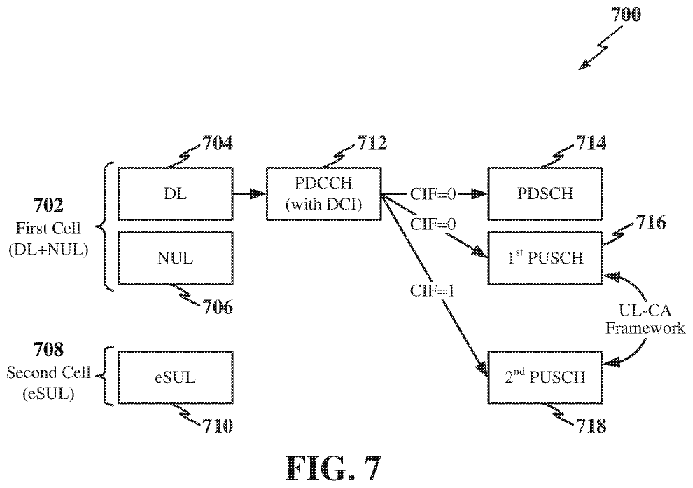

FIG. 7 is a depiction of a first exemplary configuration 700 of a first cell 702 having a DL 704 and an associated NUL 706 and a second cell 708 having an eSUL 710 according to some aspects of the disclosure. The second cell 708 lacks a DL (e.g., a second DL, different from the DL 704, associated with the second cell 708 and the eSUL 710). A DCI in a PDCCH 712 carried over the DL 704 may convey information that may be used to schedule a PDSCH 714 associated with the DL 704. In some examples, the information may be a carrier indication field (CIF). The DCI in the PDCCH 712 carried over the DL 704 may also convey information used to schedule a first PUSCH 716 associated with the NUL 706. In some examples, the information may be a carrier indication field (CIF). By way of example and not limitation, a value of the CIF associated with the PDSCH 714 and the first PUSCH 716 may be the same value (e.g., the value may be equal to 0). The DCI in the PDCCH 712 carried over the DL 704 may also convey information that may be used to schedule a second PUSCH 718 carried on the eSUL 710 of the second cell 708. In some examples, the information may be a carrier indication field (CIF). By way of example and not limitation, a value of the CIF associated with the second PUSCH 718 may be a value that is different from the value of the CIF associated with the PDSCH 714 and the first PUSCH 716 (e.g., the value may be equal to 1).

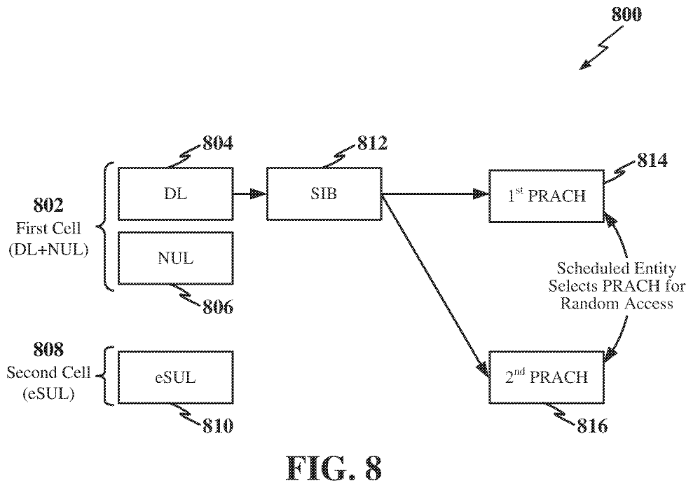

FIG. 8 is a depiction of a second exemplary configuration 800 of a first cell 802 having a DL 804 and an associated NUL 806 and a second cell 808 having an eSUL 810 according to some aspects of the disclosure. The second cell 808 lacks a DL (e.g., a second DL, different from the DL 804, associated with the second cell 808 and the eSUL 810). A SIB 812 conveyed over the DL 804 may convey information that may be used by a scheduled entity (e.g., scheduled entity 504 of FIG. 5A in connection with the application of FIG. 5 to the aspects of a secondary uplink also referred to as an enhanced SUL (eSUL) as described herein) to select either the NUL 806 or the eSUL 810 for a random access procedure. For example, the information may be a list of NULs (including NUL 806) and eSULs (including eSUL 810) that may be available to carry uplink messages in a given type of random access procedure.

The new framework of eSUL may unify the frameworks of SUL and UL-CA and enable unified support for measurement, mobility, and access. Concerning measurement, eSUL does not require a DL in the eSUL cell. Aspects described herein may indicate how or whether to enable DL measurement for eSUL. If DL measurement is not enabled for eSUL, aspects described herein may indicate how a network configures eSUL to a scheduled entity. Regarding mobility: based on scheduled entity movement, eSUL quality could change. For example, a neighboring TRP may serve eSUL for the scheduled entity with better performance and/or throughput than the current TRP serving eSUL for the scheduled entity. Aspects described herein may indicate how a network selects the best TRP to serve for eSUL for a scheduled entity in cases where DL measurement is not enabled for eSUL. Regarding access: carrier/TRP switch for eSUL may make use of a random access procedure to acquire the timing for UL transmission on eSUL. Aspects described herein may indicate how a scheduled entity may identify the timing for eSUL in cases where DL measurement is not enabled for eSUL.

Each aspect described above may prove significant in cases where eSUL is non-co-located with other cells with DL.

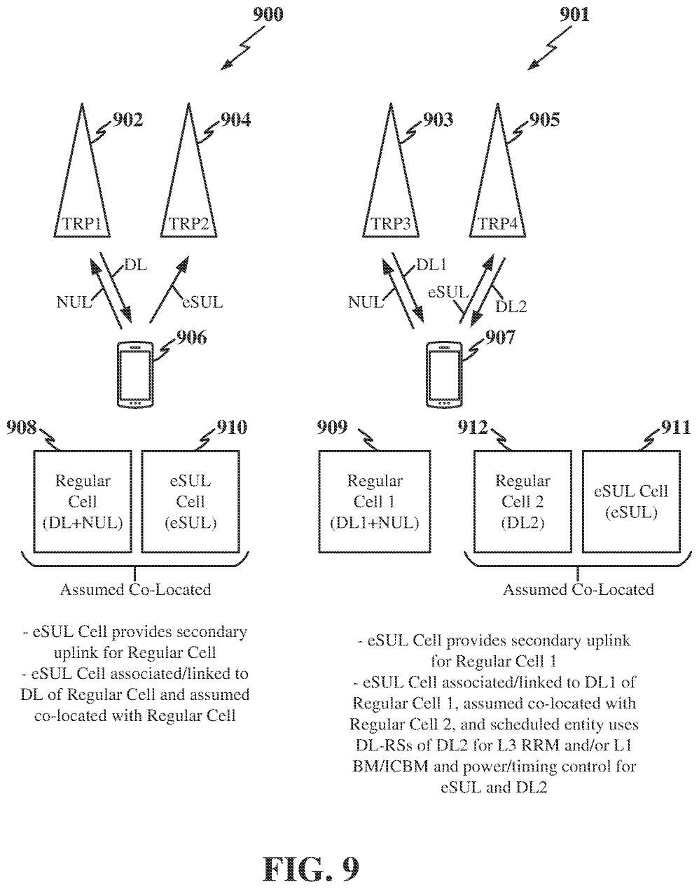

FIG. 9 is an illustration depicting two eSUL use cases according to some aspects of the disclosure. In a first use case 900, a first TRP 902 (TRP1) and a second TRP 904 (TRP2) are depicted along with a scheduled entity 906. In the first use case 900, prior to the configuration shown in FIG. 9 use case 900, the first TRP 902 was configured with a regular cell 908 serving a DL, a NUL, and an eSUL. However, a determination was made to switch the eSUL cell 910 from the first TRP 902 to the second TRP 904. The determination may have been made because the second TRP 904 may serve eSUL for the scheduled entity 906 with better performance and/or throughput than the first TRP 902. However, as shown in FIG. 9 use case 900, there is no DL associated with the eSUL cell 910 serving eSUL for the scheduled entity 906. In the first use case 900, the eSUL cell 910 may remain associated/linked to the DL of the regular cell 908 and may assume that the eSUL cell 910 is co-located with the regular cell 908.

In the second use case 901, a third TRP 903 (TRP3) and a fourth TRP 905 (TRP4) are depicted along with a scheduled entity 907. In the second use case 901, prior to the configuration shown in FIG. 9, the third TRP 903 was configured with a first regular cell 909 (regular cell 1) serving a DL, a NUL, and an eSUL. However, a determination was made to switch the eSUL cell 911 from the third TRP 903 to the fourth TRP 905. The decision may have been made because the fourth TRP 905 may serve eSUL for the scheduled entity 907 with better performance and/or throughput than the third TRP 903. In the second use case 901 of FIG. 9, after the switch, the eSUL cell 911 may remain associated/linked to the first DL (i.e., DL1) of the first regular cell 909 and may assume that the eSUL cell 911 is co-located with the second regular cell 912 having the second DL (DL2). The scheduled entity 907 may use DL RSs of the second downlink (DL2) of the second regular cell 912, for example, in connection with L3 RRM and/or L1 BM/ICBM and power/timing control for the eSUL cell 911 and for the second regular cell 912.

According to one aspect, for both the first use case 900 and the second use case 901, a scheduled entity may assume that an eSUL cell is co-located with a regular cell that has DL. The scheduled entity may use DL RSs in the assumed co-located regular cell for eSUL. According to a first option, the co-located regular cell is the one that is configured to schedule UL data on the eSUL (i.e., it may have a PDCCH carrying scheduling information related to the eSUL; it may be a scheduling cell for the eSUL). According to a second option, the assumed co-located regular cell may be configured by RRC signaling explicitly (i.e., the configured assumed co-located regular cell may be a different cell from the cell carrying scheduling information for the eSUL).

According to some aspects, a scheduled entity measures DL RSs (e.g., SSBs or CSI-RSs) on the carrier for the co-located regular cell for L3 RRM and/or L1 BM/ICBM and power/timing control for eSUL, as well as for the co-located regular cell. Cell-change/switch (e.g., HO or LTM) and beam-change/switch (e.g., TCI-state activation/indication) may be independently executed for the eSUL and the co-located regular cell. The eSUL and the co-located regular cell may belong to the same timing advance group (TAG).

In some examples, at least two options may be available in response to the regular cell that carries DL RSs for eSUL being deactivated. According to a first option, the eSUL cell may be deactivated altogether, or the UL scheduling of the eSUL may be disabled. According to a second option, the scheduled entity may switch the cell on which it monitors DL RSs for the eSUL based on predetermined rules.

For example, a first rule may indicate that the cell to which the scheduled entity monitors DL RSs for eSUL may switch to a cell within the band, a band set, or the FR where eSUL is configured. A second rule may indicate that the cell to which the scheduled entity monitors DL RSs for eSUL may switch to a cell within the TAG where eSUL is configured. If there are multiple cells that satisfy the conditions, the selection of the cell to which the scheduled entity monitors DL RSs for eSUL may be left up to scheduled entity implementation or may, for example, be based on cell indexes.

For eSUL, DL RSs may be configured for measurement, mobility, and control. For example, a scheduled entity may measure DL RSs (e.g., SSBs or CSI-RSs) for L3 RRM and L1 BM/and power/timing control for the eSUL. The carrier/frequency location (e.g., absolute radio frequency channel number (ARFCN)) of the DL RSs (e.g., SSBs or CSI-RSs) for the eSUL may be configured by RRC signaling.

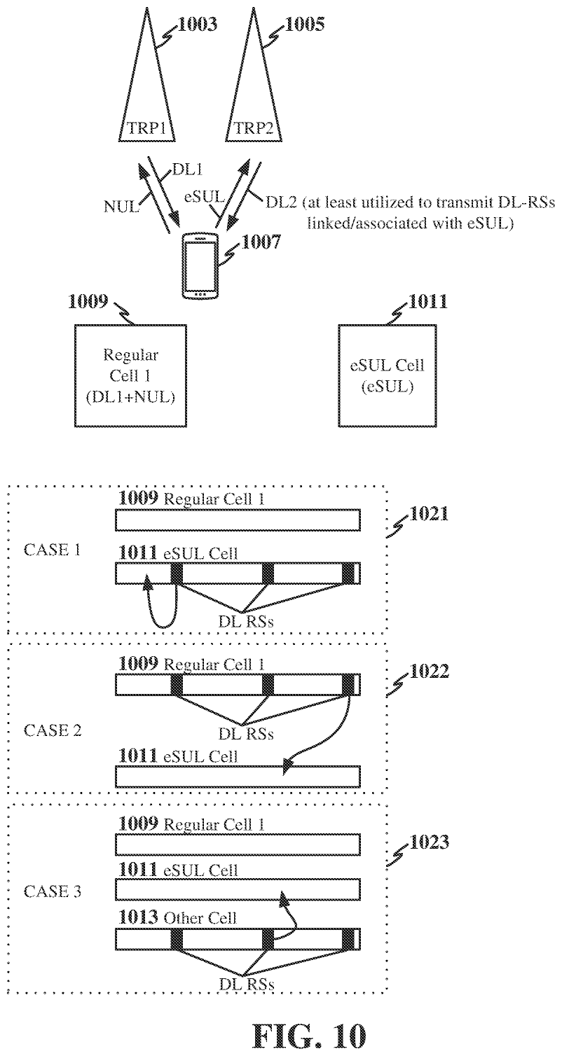

FIG. 10 is an illustration depicting three use cases (a first use case 1021, a second use case 1022, and a third use case 1023) of associations between DL RSs and an eSUL cell 1011 according to some aspects of the disclosure. In FIG. 10, a first TRP 1003 (TRP1) and a second TRP 1005 (TRP2) are depicted along with a scheduled entity 1007. The second TRP 1005 may serve eSUL for the scheduled entity 1007 with better performance and/or throughput than the first TRP 1003. In FIG. 10, the eSUL cell 1011 may be associated/linked to the DL of the first regular cell 1009. The scheduled entity 1007 may assume, for purposes of measurements of DL RSs in connection with the eSUL cell 1011, that the eSUL cell 1011 is co-located with the cell conveying the DL RSs in each of the three use cases 1021, 1022, 1023. In other words, the scheduling entity may transmit DL RSs used for measurements for eSUL cell from TRP2 1005, no matter where the DL RSs for eSUL are transmitted (e.g., transmitted as in the first use case 1021, the second use case 1022, or the third use case 1023). For example, in the second use case 1022, the scheduled entity may assume that the DL RSs for eSUL in the regular cell 1 1009 may not be transmitted from the TRP1 1003, although any other DL in the regular cell 1 1009 may be assumed to be transmitted from TRP1 (1003). In other words, the scheduled entity may receive downlink from two different (non-collocated) TRPs in the frequency for the regular cell 1 (1009).

In the first use case 1021, the DL RSs may be within the carrier bandwidth (or within the BWP) of the eSUL cell 1011. On the eSUL cell 1011, the scheduled entity 1007 may measure DL RSs, and therefore, the eSUL cell 1011 may no longer be an “uplink-only cell”. From a network's perspective, the eSUL could be a regular TDD carrier (but could still be the eSUL cell 1011 for the scheduled entity 1007). In the first use case 1021, the network may not transmit in the downlink to the scheduled entity 1007, other than the DL RSs within the carrier bandwidth (or within the BWP) of the eSUL cell 1011. In the illustrations of the first use case 1021, the arrow-headed line from a representative DL RS of the eSUL cell 1011 back to the eSUL cell 1011 is intended to indicate that the representative DL RS is to be used in connection with measurements related to the eSUL cell 1011.

In the second use case 1022, the DL RSs may be within the carrier bandwidth (or within the BWP) of the first regular cell 1009 configured to the scheduled entity 1007. In the second use case 1022, the DL RSs for the eSUL cell may be associated with the scheduling entity's 1007 DL monitoring/reception on the first regular cell 1009, simplifying the scheduled entity receiver/reception. In the illustrations of the second use case 1022, the arrow-headed line from a representative DL RS of the regular cell 1 1009 to the eSUL cell 1011 is intended to indicate that the representative DL RS is to be used in connection with measurements related to the eSUL cell 1011.

In the third use case 1023, the DL RSs may not be within any of the cells configured to the scheduled entity 1007 (e.g., not within the first regular cell 1009 or the eSUL cell 1011). Unlike the first use case 1021, in the third use case 1023, there may be no need to configure the scheduled entity 1007 as an extra regular cell. Monitoring DL RSs on another cell 1013 may be configured to the scheduled entity 1007, simplifying the scheduled entity's receiver. In the illustrations of the third use case 1023, the arrow-headed line from a representative DL RS of the other cell 1013 to the eSUL cell 1011 is intended to indicate that the representative DL RS is to be used in connection with measurements related to the eSUL cell 1011.

In some examples, the scheduled entity 1007 may measure DL RSs (e.g., SSBs or CSI-RSs) for L3 RRM and L1 BM/and power/timing control for the eSUL cell 1011. A cell-change/switch (e.g., HO or LTM) and a beam-change/switch (e.g., TCI-state activation/indication) may be executed for the eSUL based on associated DL RS measurements. The eSUL may belong to a timing advance group (TAG) with no regular cell with a DL.

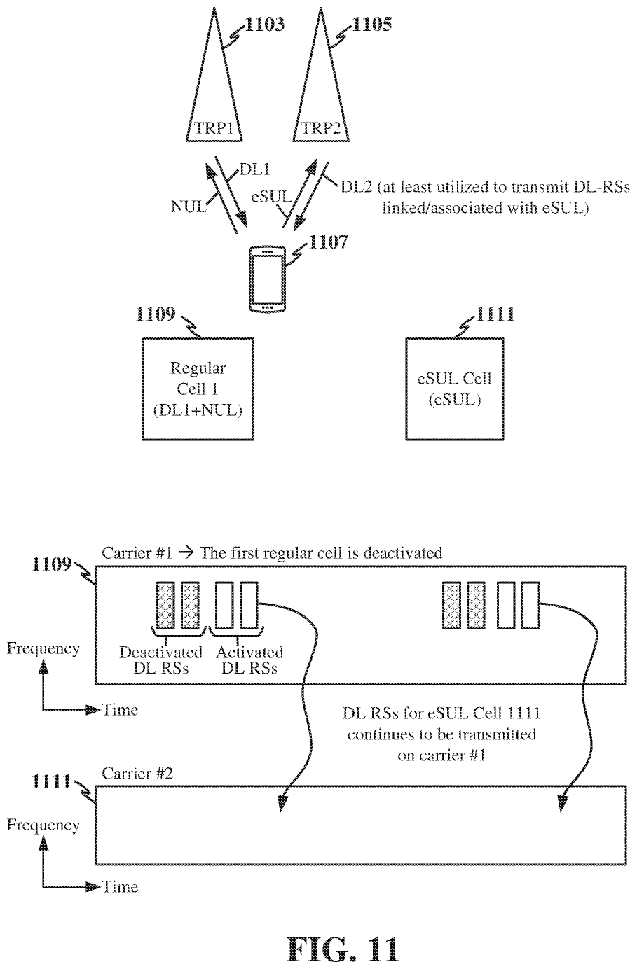

FIG. 11 depicts a scheduled entity 1107 that monitors DL RSs for eSUL on a configured carrier or frequency according to some aspects of the disclosure. In FIG. 11, a first TRP 1103 (TRP1) and a second TRP 1105 (TRP2) are depicted along with a scheduled entity 1107. The second TRP 1105 may serve eSUL for the scheduled entity 1107 with better performance and/or throughput than the first TRP 1103. In FIG. 11, the eSUL cell 1111 may remain associated/linked to the DL of the first regular cell 1109 and may assume that the eSUL cell 1111 is co-located with the regular cell 1 1109.

In FIG. 11, the scheduled entity 1107 may monitor the DL RSs (e.g., SSBs or CSI-RSs) for eSUL on a configured carrier or frequency (e.g., carrier #1) associated with the regular cell 1 1109 as long as the eSUL cell 1111 is activated. In FIG. 11, carrier #1 carries deactivated DL RSs for the regular cell 1 1109 and activated DL RSs for the eSUL cell 1111. The arrow-headed line from the activated DL RS of carrier #1 associated with the regular cell 1 1109 to the eSUL cell 1111 is intended to indicate that the activated DL RSs are to be used in connection with measurements related to the eSUL cell 1111. The scheduled entity 1107 may not monitor the DL RSs (e.g., SSBs or CSI-RSs) for the eSUL cell 1111 once the eSUL cell 1111 is deactivated. This may bold regardless of where the DL RSs are located. For example, in the second use case 1022 as shown and described in connection with FIG. 10, the DL RSs may be within the first regular cell 1009 (similar to the first regular cell 1109 of FIG. 11). Regardless of whether the first regular cell 1009 includes the DL RSs that are activated or deactivated, the scheduled entity 1107 assumes the DL RSs for the eSUL cell 1111 are transmitted on the first regular cell 1109 (similar to 1009 as shown and described in connection with FIG. 10), as long as the eSUL cell 1111 is activated.

In some examples, DL RSs for eSUL may be SSBs or CSI-RSs. An RRC configuration for DL RSs may be provided under an eSUL cell configuration or measurement configuration. For example, turning again to the second use case 1022 as shown and described in connection with FIG. 10, the configuration may be part of the cell configuration for the first regular cell 1009 (similar to the first regular cell 1109 of FIG. 11) that contains the DL RSs for eSUL.

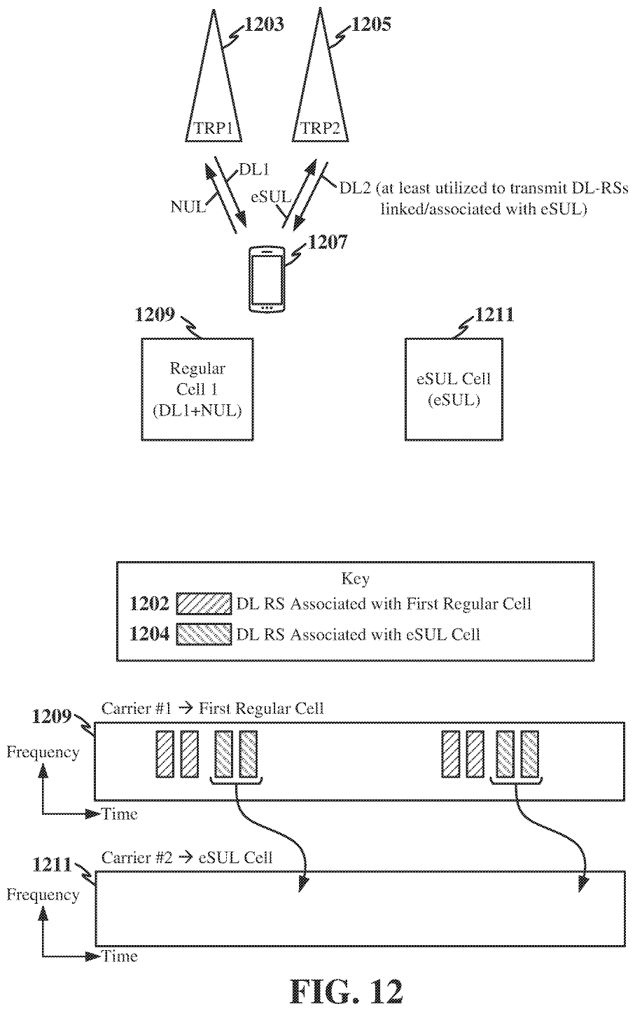

FIG. 12 depicts a scheduled entity 1207 that monitors DL RSs for eSUL on a configured carrier or frequency according to some aspects of the disclosure. The configured carrier or frequency may be, for example, carrier #1 associated with the first regular cell 1209. The arrow-headed line from the DL RSs 1204 associated with the eSUL cell 1211 is intended to indicate that the DL RSs 1204 are to be used in connection with measurements related to the eSUL cell 1211. In FIG. 12, a first TRP 1203 (TRP1) and a second TRP 1205 (TRP2) are depicted along with a scheduled entity 1207. The second TRP 1205 may serve eSUL for the scheduled entity 1207 with better performance and/or throughput than the first TRP 1203. In FIG. 12, the eSUL cell 1211 may remain associated/linked to the DL of the first regular cell 1209 and may assume that the eSUL cell 1211 is co-located with the first regular cell 1209. As noted above, an RRC configuration for DL RSs may be provided under an eSUL cell configuration or measurement configuration. Similar to the second use case 1022 as shown and described in connection with FIG. 10, the configuration may be part of the cell configuration for the first regular cell 1209 (similar to first regular cell 1009 of FIG. 10) that comprises the first DL RSs 1202 associated with the first regular cell 1209 and comprises the second DL RSs 1204 associated with the eSUL cell 1211.

In some examples, the DL RSs may be periodic DL RSs having a certain periodicity (configured as part of the RRC configuration). The periodic DL RSs may be used in connection with both IDLE and CONNECTED modes.

In other examples, the DL RSs may be semi-persistent/aperiodic DL RSs triggered/activated by a DCI/MAC-CE or other events (e.g., buffer status report/power headroom report (BSR/PHR)). The semi-persistent/aperiodic DL RSs may be utilized in connection with a CONNECTED mode.

Considering that the frequency or carrier location of the DL RSs (e.g., ARFCN) needs to be provided in the configuration, SSBs may be preferred (for NCD-SSB, ARFCN can be configured already). If the DL RSs for eSUL are NCD-SSB, the scheduled entity may monitor regular CD-SSB in the scheduling cell for PDCCH reception in the cell. The PDCCH may be for scheduling the eSUL.

In some examples, the scheduled entity may monitor NCD-SSB in the configured frequency/carrier location for eSUL. The NCD-SSB may be configured within the bandwidth (or within the BWP) of the scheduling cell. In this case, both the CD-SSB and the NCD-SSB may be within the bandwidth (or within the bandwidth part) of the scheduling cell. This situation may be similar to the reduced capability (RedCap) situation, but the following difference is noted: NCD-SSB may be configured by RRC (for CONNECTED mode) or by SIB (for IDLE mode) (for RedCap, only by RRC and for CONNECTED mode).

The scheduled entity may monitor both regular CD-SSB and the NCD-SSB in the regular cell (for RedCap, only one of them is monitored). CD-SSB is for everything in the regular cell, while the NCD-SSB is for the eSUL cell.

For random access using the eSUL: SIB, RRC, and PDCCH-order may use CD-SSB as the quasi-co-located (QCL) source; Msg2, Msg4, and PDCCH may use CD-SSB as the QCL source; and Msg1, Msg3, and PUCCH may use NCD-SSB as the QCL source.

Aspects of eSUL related to DL measurements, mobility, and access are described below in connection with descriptions of hardware implementations of a scheduled entity (e.g., an apparatus) and a scheduling entity (e.g., a network entity).

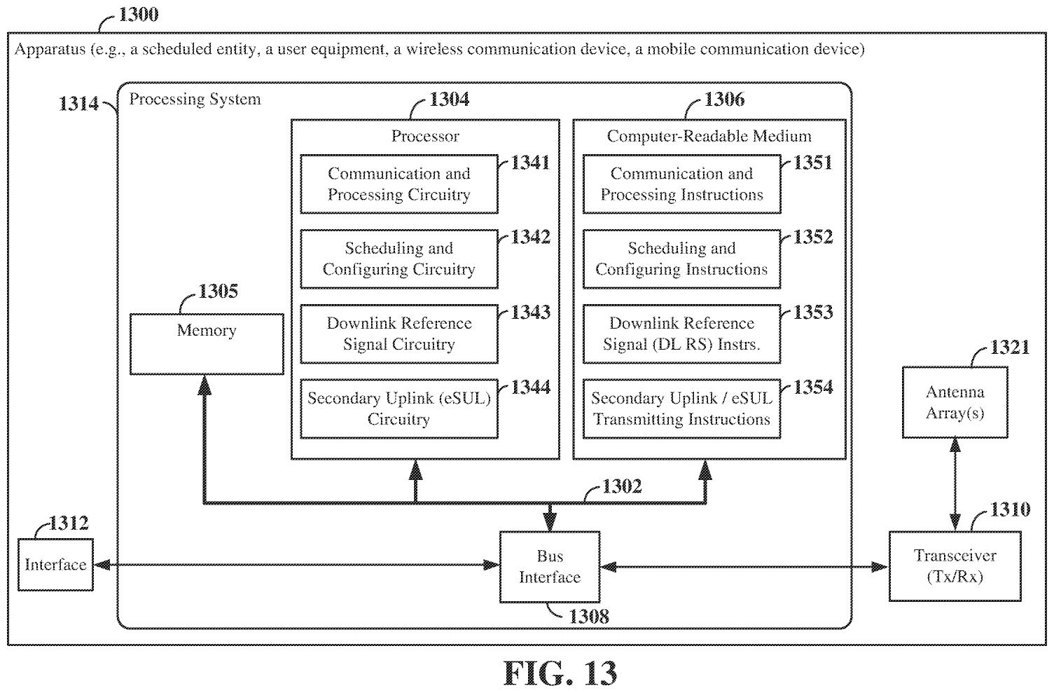

FIG. 13 is a block diagram illustrating an example of a hardware implementation of an apparatus 1300 (e.g., a scheduled entity, a user equipment, a wireless communication device, a mobile communication device) employing one or more processing systems (generally represented by processing system 1314) according to some aspects of the disclosure. The apparatus 1300 may be similar to, for example, any of the scheduled entities, user equipment, wireless communication devices, and mobile communication devices as shown and described in connection with FIGS. 1-3 and 5-12.

In accordance with various aspects of the disclosure, an element, any portion of an element, or any combination of elements may be implemented with a processing system 1314 that includes one or more processors, generally represented by processor 1304. Examples of processor 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1300 may be configured to perform any one or more of the functions described herein. That is, the one or more processors (generally represented by processor 1304), as utilized in the apparatus 1300, may be configured to, individually or collectively, implement any one or more of the methods or processes described and illustrated, for example, in FIGS. 5-12.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 communicatively couples together various circuits, including one or more processors (represented generally by the processor 1304), one or more memories (represented generally by a memory 1305), and one or more computer-readable media (represented generally by the computer-readable medium 1306). The bus 1302 may also link various other circuits such as timing sources, peripherals, voltage regulators, and power management circuits, which are well known to persons having ordinary skill in the art, and, therefore, will not be described any further.

A bus interface 1308 provides an interface between the bus 1302 and a transceiver 1310. The transceiver 1310 may be, for example, a wireless transceiver. The transceiver 1310 may be operational with multiple RATs (e.g., LTE, 5G NR, IEEE 802.11 (WiFi®), etc.). The transceiver 1310 may provide respective means for communicating with various other apparatus. UEs, and core networks over a transmission medium (e.g., air interface). The transceiver 1310 may be coupled to one or more antenna array(s) 1321. The bus interface 1308 may provide an interface between the bus 1302 and a user interface 1312 (e.g., keypad, display, touch screen, speaker, microphone, control features, vibration circuit/device, etc.). Of course, such a user interface 1312 is optional and may be omitted in some examples.

One or more processors, represented individually and collectively by processor 1304, may be responsible for managing the bus 1302 and general processing, including the execution of software stored on the computer-readable medium 1306. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1306. The software, when executed by the processor 1304, causes the processing system 1314 to perform the various processes and functions described herein for any particular apparatus.

The computer-readable medium 1306 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities, including the processing system 1314. The computer-readable medium 1306 may be embodied in a computer program product or article of manufacture. By way of example, a computer program product or article of manufacture may include a computer-readable medium in packaging materials. In some examples, the computer-readable medium 1306 may be part of the memory 1305. Persons having ordinary skill in the art will recognize how best to implement the described functionality presented throughout this disclosure depending on the particular application and the overall design constraints imposed on the overall system. The computer-readable medium 1306 and/or the memory 1305 may also be used for storing data that is manipulated by the processor 1304 when executing software.

In some aspects of the disclosure, the processor 1304 may include communication and processing circuitry 1341 configured for various functions, including, for example, communicating with a scheduling entity (e.g., base station, an eNB, a gNB, a network entity), another apparatus, and/or a core network. In some examples, the communication and processing circuitry 1341 may include one or more hardware components that provide the physical structure that performs processes related to wireless communication (e.g., signal reception and/or signal transmission) and signal processing (e.g., processing a received signal and/or processing a signal for transmission). The communication and processing circuitry 1341 may also be configured to execute a mobility determination associated with the secondary uplink. In some examples, the mobility determination may correspond to at least one of: a cell-change, a cell-switch, a beam-change, or a beam-switch. The communication and processing circuitry 1341 may further be configured to execute communication and processing instructions 1351 (e.g., software) stored on the computer-readable medium 1306 to implement one or more functions described herein.

In some aspects of the disclosure, the processor 1304 may include scheduling and configuring circuitry 1342 configured for various functions, including, for example, receiving, in a downlink on a first cell, scheduling information configured to schedule a secondary uplink on a second cell, different from the first cell. The secondary uplink may alternatively be referred to as an enhanced SUL (eSUL). In some examples, the secondary uplink on the second cell, and another uplink on at least one of: the first cell, or the third cell (or a given uplink on the first cell) may belong to a same timing advance group (TAG). The scheduling and configuring circuitry 1342 may also be configured to receive radio resource control signaling to configure a location of downlink reference signals used in association with a secondary uplink, wherein the downlink reference signals are at least one of: within a first carrier bandwidth or a first bandwidth part of the secondary uplink, within a second carrier bandwidth or a second bandwidth part of a second cell configured to the apparatus for a non-secondary uplink, or are not within any cell configured to the apparatus; and transmitting the secondary uplink at a transmit power level or with a timing control determined with the downlink reference signals. The scheduling and configuring circuitry 1342 may further be configured to execute scheduling and configuring instructions 1352 (e.g., software) stored on the computer-readable medium 1306 to implement one or more functions described herein.

In some aspects of the disclosure, the processor 1304 may include downlink reference signal circuitry 1343 configured for various functions, including, for example, receiving downlink reference signals on a first cell, or receiving: radio resource control signaling that configures a third cell on which the downlink reference signals are received, the third cell being the same as or different from the first cell, and receiving the downlink reference signals on the third cell. According to some aspects, the secondary uplink may have no associated downlink in the second cell. In some examples, the downlink reference signal circuitry 1343 may also be configured to use the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink on the second cell and another uplink on at least one of: the first cell, or the third cell. The downlink reference signal circuitry 1343 may also be configured to monitor the downlink reference signals associated with the secondary uplink in response to an activation of the secondary uplink; and cease the monitoring of the downlink reference signals associated with the secondary uplink in response to a deactivation of the secondary uplink. According to some aspects, the downlink reference signals may be at least one of: a synchronization signal/physical broadcast channel block (SSB), or a channel state information-reference signal (CSI-RS). According to some examples, a radio resource control configuration for the downlink reference signals may be provided under at least one of: a secondary uplink cell configuration, or a secondary uplink measurement configuration. In some examples, the downlink reference signals may be: periodic in IDLE mode, and periodic, semi-persistent, or aperiodic in CONNECTED mode. In some examples, in response to the downlink reference signals associated with the secondary uplink being non-cell defining synchronization signal/physical broadcast channel blocks (NCD-SSBs), the downlink reference signal circuitry 1343 may also be configured to monitor cell defining-SSBs (CD-SSBs) in a cell scheduling the secondary uplink; and monitor the NCD-SSBs in a configured frequency or carrier location associated with the secondary uplink. In some examples, the NCD-SSBs may be configured within a third bandwidth, or within a third bandwidth part, of the cell scheduling the secondary uplink; and both the CD-SSBs and the NCD-SSBs may be within the third bandwidth or within the third bandwidth part of the cell scheduling the secondary uplink. According to some aspects, the NCD-SSBs may be configured by at least one of: radio resource control signaling in a CONNECTED mode, or system information broadcast (SIB) in an IDLE mode. According to some examples, the apparatus 1300, the processor 1304, or, more particularly, the downlink reference signal circuitry 1343 may monitor both CD-SSBs and NCD-SSBs in the cell scheduling the secondary uplink. In some examples, the apparatus 1300, the processor 1304, or, more particularly, the downlink reference signal circuitry 1343 may monitor NCD-SSBs in association with processes related to the secondary uplink and monitor CD-SSBs in association with processes related to the cell scheduling the secondary uplink. The downlink reference signal circuitry 1343 may further be configured to execute downlink reference signal instructions 1353 (e.g., software) stored on the computer-readable medium 1306 to implement one or more functions described herein.

In some aspects of the disclosure, the processor 1304 may include secondary uplink (eSUL) circuitry 1344 configured for various functions, including, for example, transmitting the secondary uplink on the second cell. The secondary uplink (eSUL) circuitry 1344 may further be configured to transmit the secondary uplink on the second cell at a transmit power level or with a timing control determined with the downlink reference signals received on the at least one of: the first cell in response to receiving the downlink reference signals on the first cell, or the third cell in response to receiving the radio resource control signaling configuring the third cell. Another function for which the secondary uplink (eSUL) circuitry 1344 may be configured may include monitoring the deactivation of cells, and upon deactivation of the at least one of: the first cell, or the third cell, respectively, the method further comprises at least one of: deactivating the secondary uplink on the second cell, disabling the scheduling of the secondary uplink on the second cell, or switching a monitoring of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus. The secondary uplink (eSUL) circuitry 1344 may further be configured to execute secondary uplink (eSUL) instructions 1354 (e.g., software) stored on the computer-readable medium 1306 to implement one or more functions described herein.

In general, an apparatus, such as the apparatus 1300, may include one or more memories (e.g., represented by memory 1305), and one or more processors (e.g., represented by processor 1304), the one or more processors may be configured to, individually or collectively, based at least in part on information stored in the one or more memories: perform any of the processes described herein.

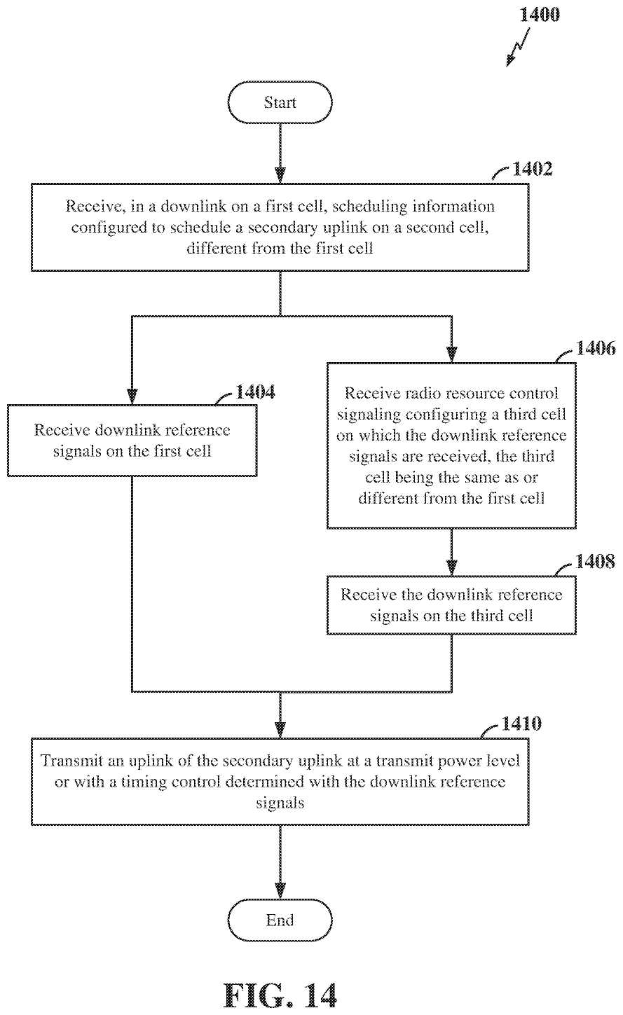

FIG. 14 is a flow chart illustrating an example process 1400 (e.g., a method) of wireless communication at an apparatus (e.g., a scheduled entity, a user equipment, a wireless communications device, a mobile communication device) according to some aspects of the disclosure. As described below, some or all illustrated features may be omitted in a particular implementation within the scope of the present disclosure, and some illustrated features may not be required for the implementation of all embodiments. In some examples, the process 1400 may be carried out by the apparatus 1300, as shown and described in connection with FIG. 13. The apparatus 1300 may be similar to, for example, any of the scheduled entities of FIGS. 1-3 and 5-13. In some examples, the process 1400 may be carried out by any suitable apparatus or means for carrying out the functions or algorithm described below.

At block 1402, the apparatus may receive, in a downlink on a first cell, scheduling information configured to schedule a secondary uplink on a second cell, different from the first cell. The secondary uplink may alternatively be referred to as an enhanced SUL (eSUL). For example, the scheduling and configuring circuitry 1342, as shown and described in connection with FIG. 13, may provide a means for receiving, in a downlink on a first cell, scheduling information configured to schedule a secondary uplink on a second cell, different from the first cell. According to some aspects of the disclosure, the secondary uplink may have no associated downlink in the second cell.

In some examples, the process 1400 may include independently executing mobility determinations for the secondary uplink on the second cell and another uplink on at least one of: the first cell, or the third cell. In other words, independently executing a respective mobility determination for the secondary uplink on the second cell and another uplink on at least one of: the first cell, or the third cell. For example, the communication and processing circuitry 1341, as shown and described in connection with FIG. 13, may provide a means for independently executing mobility determinations for the secondary uplink on the second cell and another uplink on at least one of: the first cell, or the third cell. According to some aspects, the mobility determinations may correspond to at least one of: a cell-change, a cell-switch, a beam-change, or a beam-switch. In some examples, the secondary uplink on the second cell, and another uplink on at least one of: the first cell, or the third cell may belong to a same timing advance group (TAG). The process 1400 may proceed to at least one of block 1404 or block 1406.

At block 1404, the apparatus may receive downlink reference signals on the first cell. For example, the scheduling and configuring circuitry 1342, as shown and described in connection with FIG. 13, may provide a means for receiving downlink reference signals on the first cell. The process 1400 may continue at block 1410, or if block 1404 was not exercised, the process may turn to block 1406.

At block 1406, the apparatus may, alternatively to, or in addition to the process at block 1404, receive radio resource control signaling configuring a third cell on which the downlink reference signals are received, the third cell being the same as or different from the first cell. For example, the scheduling and configuring circuitry 1342, as shown and described in connection with FIG. 13, may provide a means for receiving radio resource control signaling configuring a third cell on which the downlink reference signals are received, the third cell being the same as or different from the first cell.

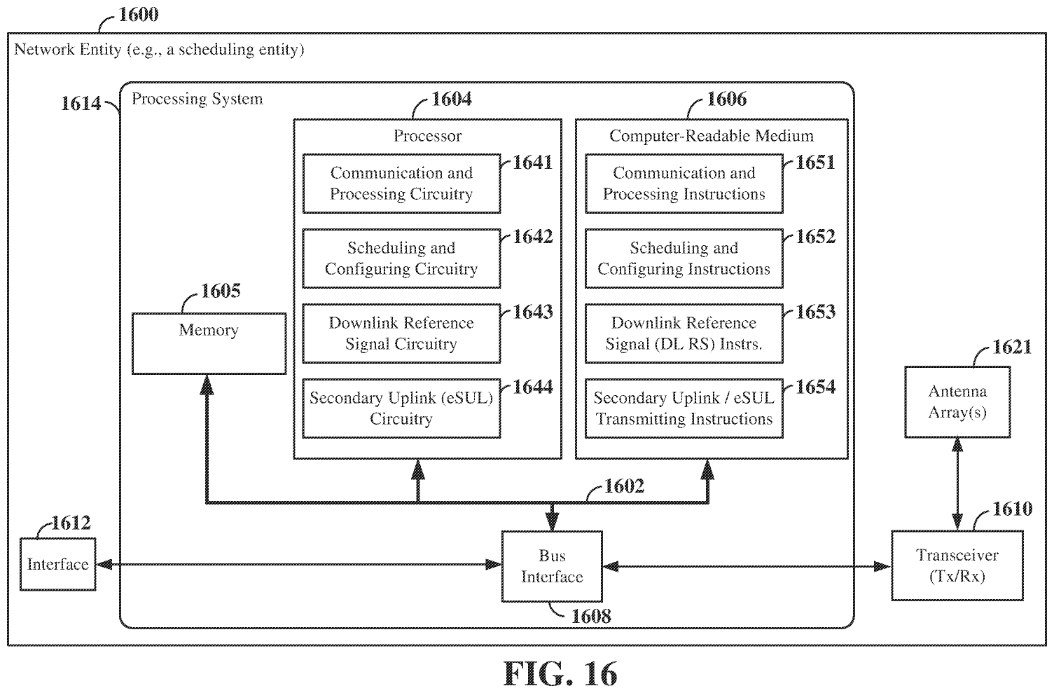

At block 1408, the apparatus may receive the downlink reference signals on the third cell. For example, the scheduling and configuring circuitry 1642, as shown and described in connection with FIG. 16, may provide a means for receiving the downlink reference signals on the third cell.

In some examples, the process 1400 may include using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink on the second cell and another uplink on at least one of: the first cell, or the third cell. For example, the downlink reference signal circuitry 1343, as shown and described in connection with FIG. 13, may provide a means for using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink on the second cell and another uplink on at least one of: the first cell, or the third cell. The process 1400 may continue at block 1408.

At block 1410, the apparatus may transmit the secondary uplink at a transmit power level or with a timing control determined with the downlink reference signals. For example, the secondary uplink (eSUL) circuitry 1344, as shown and described in connection with FIG. 13, may provide a means for transmitting the secondary uplink at a transmit power level or with a timing control determined with the downlink reference signals.

According to some examples, the process 1400 may also include transmitting the secondary uplink on the second cell at a transmit power level or with a timing control determined with the downlink reference signals received on the at least one of: the first cell in response to receiving the downlink reference signals on the first cell, or the third cell in response to receiving the radio resource control signaling configuring the third cell. For example, the secondary uplink (eSUL) circuitry 1344, as shown and described in connection with FIG. 13, may provide a means for transmitting the secondary uplink on the second cell at a transmit power level or with a timing control determined with the downlink reference signals received on the at least one of: the first cell in response to receiving the downlink reference signals on the first cell, or the third cell in response to receiving the radio resource control signaling configuring the third cell.

According to some aspects, the apparatus may monitor cells for, for example, deactivations, and upon a deactivation of the at least one of: the first cell, or the third cell, respectively, the process 1400 may further comprise at least one of: deactivating the secondary uplink on the second cell, disabling the scheduling of the secondary uplink on the second cell, or switching a monitoring of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus. For example, the communication and processing circuitry 1341, as shown and described in connection with FIG. 13, may provide a means for deactivating the secondary uplink on the second cell, disabling the scheduling of the secondary uplink on the second cell, or switching a monitoring of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus.

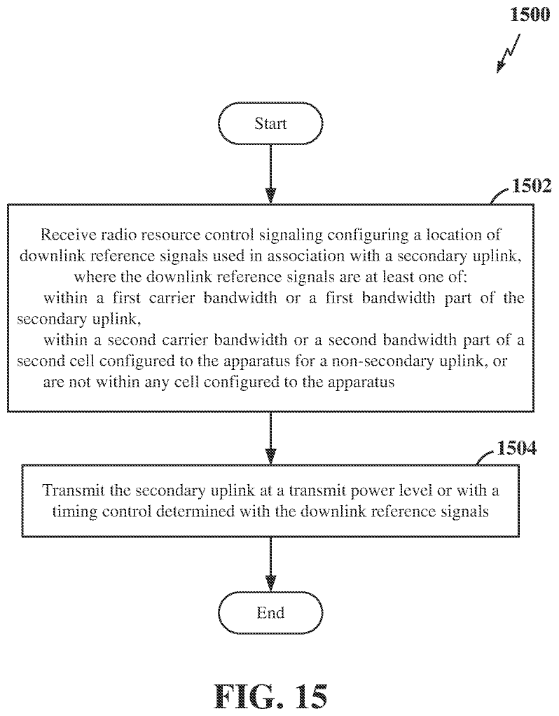

FIG. 15 is a flow chart illustrating an example process 1500 (e.g., a method) of wireless communication at an apparatus (e.g., a scheduled entity, a user equipment, a wireless communications device, a mobile communication device) according to some aspects of the disclosure. As described below, some or all illustrated features may be omitted in a particular implementation within the scope of the present disclosure, and some illustrated features may not be required for implementation of all embodiments. In some examples, the process 1500 may be carried out by the apparatus 1300, as illustrated and described in connection with FIG. 13. The apparatus 1300 may be similar to, for example, any of the scheduled entities of FIGS. 1-3 and 5-13. In some examples, the process 1500 may be carried out by any suitable apparatus or means for carrying out the functions or algorithm described below.

At block 1502, the apparatus may receive radio resource control signaling configuring a location of downlink reference signals used in association with a secondary uplink. The downlink reference signals may be at least one of: within a first carrier bandwidth or a first bandwidth part of the secondary uplink, within a second carrier bandwidth or a second bandwidth part of a second cell configured to the apparatus for a non-secondary uplink, or are not within any cell configured to the apparatus. For example, the downlink reference signal circuitry 1343, as shown and described in connection with FIG. 13, may provide a means for receiving radio resource control signaling configuring a location of downlink reference signals used in association with a secondary uplink (where the downlink reference signals may be at least one of: within a first carrier bandwidth or a first bandwidth part of the secondary uplink, within a second carrier bandwidth or a second bandwidth part of a second cell configured to the apparatus for a non-secondary uplink, or are not within any cell configured to the apparatus). According to some aspects, the secondary uplink on the second cell, and a given uplink on the first cell belong to a same timing advance group (TAG).

In some examples, the downlink reference signals are at least one of: a synchronization signal/physical broadcast channel block (SSB), or a channel state information-reference signal (CSI-RS). In some examples, a radio resource control configuration for the downlink reference signals is provided under at least one of: a secondary uplink cell configuration, or a secondary uplink measurement configuration. In still other examples, the downlink reference signals are: periodic in IDLE mode, and periodic, semi-persistent, or aperiodic in CONNECTED mode.

In still other examples, in response to the downlink reference signals associated with the secondary uplink being non-cell defining synchronization signal/physical broadcast channel blocks (NCD-SSBs), the process 1500 may further comprise: monitoring cell defining-SSBs (CD-SSBs) in a cell scheduling the secondary uplink; and monitoring the NCD-SSBs in a configured frequency or carrier location associated with the secondary uplink. For example, the communication and processing circuitry 1341, as shown and described in connection with FIG. 13, may provide a means for monitoring cell defining-SSBs (CD-SSBs) in a cell scheduling the secondary uplink; and monitoring the NCD-SSBs in a configured frequency or carrier location associated with the secondary uplink in response to the downlink reference signals associated with the secondary uplink being non-cell defining synchronization signal/physical broadcast channel blocks (NCD-SSBs). According to some aspects, the NCD-SSBs may be configured within a third bandwidth or within a third bandwidth part of the cell scheduling the secondary uplink; and both the CD-SSBs and the NCD-SSBs may be within the third bandwidth or within the third bandwidth part of the cell scheduling the secondary uplink. According to some aspects, the NCD-SSBs may be configured by at least one of: radio resource control signaling in a CONNECTED mode, or system information broadcast (SIB) in an IDLE mode. In some examples, the process 1400 may include monitoring both CD-SSBs and NCD-SSBs in the cell scheduling the secondary uplink. In some examples, the process 1400 may include monitoring NCD-SSBs in association with processes related to the secondary uplink and monitors CD-SSBs in association with processes related to the cell scheduling the secondary uplink.

At block 1504, the apparatus may transmit the secondary uplink at a transmit power level or with a timing control determined with the downlink reference signals. For example, the secondary uplink (eSUL) circuitry 1344, as shown and described in connection with FIG. 13, may provide a means for transmitting the secondary uplink at a transmit power level or with a timing control determined with the downlink reference signals. According to some aspects, the secondary uplink has no associated downlink within a cell carrying the secondary uplink.

In some examples, the process 1500 may include using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink. For example, the communication and processing circuitry 1341, as shown and described in connection with FIG. 13, may provide a means for using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink.

In some examples, the process 1500 may include executing a mobility determination associated with the secondary uplink. According to some aspects, the mobility determination corresponds to at least one of: a cell-change, a cell-switch, a beam-change, or a beam-switch. For example, the communication and processing circuitry 1341, as shown and described in connection with FIG. 13, may provide a means for executing a mobility determination associated with the secondary uplink.

In some examples, the process 1500 may include monitoring the downlink reference signals associated with the secondary uplink in response to an activation of the secondary uplink; and ceasing the monitoring of the downlink reference signals associated with the secondary uplink in response to a deactivation of the secondary uplink. For example, the downlink reference signal circuitry 1343, as shown and described in connection with FIG. 13, may provide a means for monitoring the downlink reference signals associated with the secondary uplink in response to an activation of the secondary uplink; and ceasing the monitoring of the downlink reference signals associated with the secondary uplink in response to a deactivation of the secondary uplink.

FIG. 16 is a block diagram illustrating an example of a hardware implementation of a network entity 1600 (e.g., a base station, an aggregated or disaggregated base station, a gNB, a TRP, a scheduling entity) employing one or more processing systems (generally represented by processing system 1614) according to some aspects of the disclosure. The network entity 1600 may be similar to, for example, any of the network entities, TRPs, scheduling entities, base stations, eNBs, or gNBs of FIGS. 1-3 and 5-12.

The processing system 1614 may be substantially the same as the processing system 1314 illustrated in FIG. 13, including a bus interface 1608, a bus 1602, one or more memories, such as memory 1605, one or more processors, such as processor 1604, and one or more computer-readable mediums, such as computer-readable medium 1606, and a user interface, such as user interface 1612.

In accordance with various aspects of the disclosure, an element, or any portion of an element, or any combination of elements may be implemented with a processing system 1614 that includes one or more processors, generally represented by processor 1604. The one or more processors (generally represented by processor 1604), as utilized in the network entity 1600, may be configured to, individually or collectively, implement any one or more of the methods or processes described herein and illustrated, for example, in FIGS. 5-12.

In some aspects of the disclosure, the processor 1604 may include communication and processing circuitry 1641 configured for various functions, including, for example, communicating with an apparatus (e.g., a schedules entity, a user equipment), another network entity, and/or a core network. In some examples, the communication and processing circuitry 1641 may include one or more hardware components that provide the physical structure that performs processes related to communication (e.g., data reception and/or data transmission) and signal processing (e.g., processing received data and/or processing data for transmission). The communication and processing circuitry 1641 may further be configured to execute communication and processing instructions 1651 (e.g., software) stored on the computer-readable medium 1606 to implement one or more functions described herein.

In some aspects of the disclosure, the processor 1604 may include scheduling and configuring circuitry 1642 configured for various functions, including, for example, transmitting, in a downlink on a first cell, scheduling information configured to schedule a secondary uplink on a second cell, different from the first cell. The secondary uplink may alternatively be referred to as an enhanced SUL (eSUL). In some examples, the secondary uplink on the second cell, and another uplink on at least one of: the first cell, or the third cell may (or a given uplink on the first cell) belong to a same timing advance group (TAG). The scheduling and configuring circuitry 1642 may also be configured to transmit radio resource control signaling configuring a location of downlink reference signals used in association with a secondary uplink, where the downlink reference signals are at least one of: within a first carrier bandwidth or a first bandwidth part of the secondary uplink, within a second carrier bandwidth or a second bandwidth part of a second cell configured to an apparatus for a non-secondary uplink, or are not within any cell configured to the apparatus. The network entity 1600 may also receive the secondary uplink at a power level or with a timing control determined with the downlink reference signals. The scheduling and configuring circuitry 1642 may further be configured to execute scheduling and configuring instructions 1652 (e.g., software) stored on the computer-readable medium 1606 to implement one or more functions described herein.

In some aspects of the disclosure, the processor 1604 may include downlink reference signal circuitry 1643 configured for various functions, including, for example, transmitting downlink reference signals on a first cell, or transmitting: radio resource control signaling configuring a third cell on which the downlink reference signals are transmitted, the third cell being the same as or different from the first cell, and transmitting the downlink reference signals on the third cell. According to some aspects, the secondary uplink may have no associated downlink in the second cell. In some examples, the downlink reference signal circuitry 1643 may also be configured to use the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink on the second cell and another uplink on at least one of: the first cell, or the third cell. The downlink reference signal circuitry 1643 may also be configured to activate and/or deactivate the downlink reference signals associated with the secondary uplink in association with an activation and/or deactivation of the secondary uplink. According to some aspects, the downlink reference signals may be at least one of: a synchronization signal/physical broadcast channel block (SSB), or a channel state information-reference signal (CSI-RS). According to some examples, a radio resource control configuration for the downlink reference signals may be provided under at least one of: a secondary uplink cell configuration, or a secondary uplink measurement configuration. In some examples, the downlink reference signals may be: periodic in IDLE mode, and periodic, semi-persistent, or aperiodic in CONNECTED mode. In some examples, in response to the downlink reference signals associated with the secondary uplink being non-cell defining synchronization signal/physical broadcast channel blocks (NCD-SSBs), the downlink reference signal circuitry 1643 may also be configured to transmit cell defining-SSBs (CD-SSBs) in a cell scheduling the secondary uplink; and transmit the NCD-SSBs in a configured frequency or carrier location associated with the secondary uplink. In some examples, the NCD-SSBs may be configured within a third bandwidth or within a third bandwidth part of the cell scheduling the secondary uplink; and both the CD-SSBs and the NCD-SSBs may be within the third bandwidth or within the third bandwidth part of the cell scheduling the secondary uplink. According to some aspects, the NCD-SSBs may be configured by at least one of: radio resource control signaling in a CONNECTED mode, or system information broadcast (SIB) in an IDLE mode. According to some examples, the network entity 1600, the processor 1604, or more particularly the downlink reference signal circuitry 1643, may transmit both CD-SSBs and NCD-SSBs in the cell scheduling the secondary uplink. In some examples, the network entity 1600, the processor 1604, or more particularly the downlink reference signal circuitry 1643 may transmit NCD-SSBs in association with processes related to the secondary uplink and transmit CD-SSBs in association with processes related to the cell scheduling the secondary uplink. The downlink reference signal circuitry 1643 may further be configured to execute downlink reference signal instructions 1653 (e.g., software) stored on the computer-readable medium 1606 to implement one or more functions described herein.

In some aspects of the disclosure, the processor 1604 may include secondary uplink (eSUL) circuitry 1644 configured for various functions, including, for example, receiving the secondary uplink on the second cell. The secondary uplink (eSUL) circuitry 1644 may further be configured to receive the secondary uplink on the second cell at a power level or with a timing control determined with the downlink reference signals transmitted on the at least one of: the first cell in association with transmitting the downlink reference signals on the first cell, or the third cell in in association with transmitting the radio resource control signaling configuring the third cell. Another function for which the secondary uplink (eSUL) circuitry 1644 may be configured may include deactivation of cells, and upon deactivation of the at least one of: the first cell, or the third cell, respectively, the method further comprises at least one of: deactivating the secondary uplink on the second cell, disabling the scheduling of the secondary uplink on the second cell, or switching a transmission of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus (e.g., 1300 of FIG. 13). The secondary uplink (eSUL) circuitry 1644 may further be configured to execute secondary uplink (eSUL) instructions 1654 (e.g., software) stored on the computer-readable medium 1606 to implement one or more functions described herein.

In general, a network entity, such as the network entity 1600, may include one or more memories (e.g., represented by memory 1605), and one or more processors (e.g., represented by processor 1604), the one or more processors may be configured to, individually or collectively, based at least in part on information stored in the one or more memories: perform any of the processes described herein.

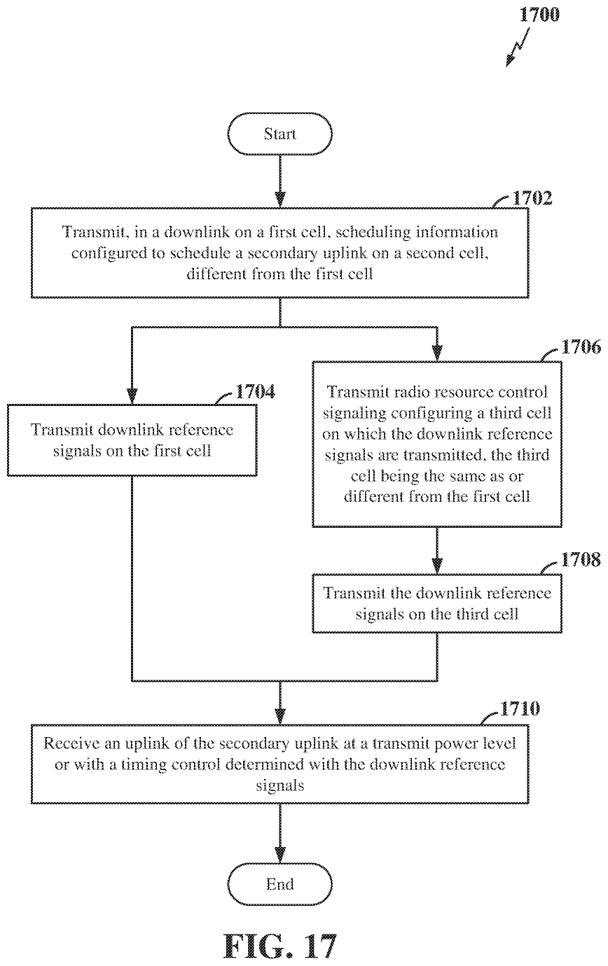

FIG. 17 is a flow chart illustrating an example process 1700 (e.g., a method) of wireless communication at a network entity (e.g., a base station, an aggregated or disaggregated base station, a gNB, a TRP, a scheduling entity) according to some aspects of the disclosure. As described below, some or all illustrated features may be omitted in a particular implementation within the scope of the present disclosure, and some illustrated features may not be required for the implementation of all embodiments. In some examples, the process 1700 may be carried out by the network entity 1600, as shown and described in connection with FIG. 16. The network entity 1600 may be similar to, for example, any of the network entities (e.g., base stations, aggregated or disaggregated base stations, gNBs. TRPs, scheduling entities) of FIGS. 1-3, 5-12, and/or 16. In some examples, the process 1700 may be carried out by any suitable apparatus or means for carrying out the functions or algorithm described below.

At block 1702, the network entity may transmit, in a downlink on a first cell, scheduling information configured to schedule a secondary uplink on a second cell, different from the first cell. The secondary uplink may alternatively be referred to as an enhanced SUL (eSUL). For example, the scheduling and configuring circuitry 1642, as shown and described in connection with FIG. 16, may provide a means for transmitting, in a downlink on a first cell, scheduling information configured to schedule a secondary uplink on a second cell, different from the first cell. According to some aspects of the disclosure, the secondary uplink may have no associated downlink in the second cell.

In some examples, the process 1700 may include independently executing mobility determinations for the secondary uplink on the second cell and another uplink on at least one of: the first cell, or the third cell. In other words, independently executing a respective mobility determination for the secondary uplink on the second cell and another uplink on at least one of: the first cell, or the third cell. For example, the communication and processing circuitry 1641, as shown and described in connection with FIG. 16, may provide a means for independently executing mobility determinations for the secondary uplink on the second cell and another uplink on at least one of: the first cell, or the third cell. According to some aspects, the mobility determinations may correspond to at least one of: a cell-change, a cell-switch, a beam-change, or a beam-switch. In some examples, the secondary uplink on the second cell, and another uplink on at least one of: the first cell, or the third cell, may belong to a same timing advance group (TAG). The process 1700 may proceed to at least one of block 1704 or block 1706.

At block 1704, the network entity may transmit downlink reference signals on the first cell. For example, the scheduling and configuring circuitry 1642, as shown and described in connection with FIG. 16, may provide a means for transmitting downlink reference signals on the first cell. The process 1700 may continue at block 1710, or if block 1704 was not exercised, the process may turn to block 1706.

At block 1706, the network entity may, alternatively to, or in addition to the process at block 1704, transmit radio resource control signaling configuring a third cell on which the downlink reference signals are transmitted, the third cell being the same as or different from the first cell. For example, the scheduling and configuring circuitry 1642, as shown and described in connection with FIG. 16, may provide a means for transmitting radio resource control signaling configuring a third cell on which the downlink reference signals are transmitted, the third cell being the same as or different from the first cell.

At block 1708, the network entity may transmit the downlink reference signals on the third cell. For example, the scheduling and configuring circuitry 1642, as shown and described in connection with FIG. 16, may provide a means for transmitting the downlink reference signals on the third cell.

In some examples, the process 1700 may include using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink on the second cell and another uplink on at least one of: the first cell, or the third cell. For example, the downlink reference signal circuitry 1643, as shown and described in connection with FIG. 16, may provide a means for using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink on the second cell and another uplink on at least one of: the first cell, or the third cell. The process 1700 may continue at block 1710.

At block 1710, the network entity may receive the secondary uplink at a transmit power level or with a timing control determined with the downlink reference signals. For example, the secondary uplink (eSUL) circuitry 1644, as shown and described in connection with FIG. 16, may provide a means for receiving the secondary uplink at a transmit power level or with a timing control determined with the downlink reference signals.

According to some examples, the process 1700 may also include receiving the secondary uplink on the second cell at a transmit power level or with a timing control determined with the downlink reference signals received on the at least one of: the first cell in response to transmitting the downlink reference signals on the first cell, or the third cell in response to transmitting the radio resource control signaling configuring the third cell. For example, the secondary uplink (eSUL) circuitry 1644, as shown and described in connection with FIG. 16, may provide a means for receiving the secondary uplink on the second cell at a transmit power level or with a timing control determined with the downlink reference signals received on the at least one of: the first cell in response to transmitting the downlink reference signals on the first cell, or the third cell in response to transmitting the radio resource control signaling configuring the third cell.

According to some aspects, the network entity may deactivate cells, and upon a deactivation of the at least one of: the first cell, or the third cell, respectively, the process 1700 may further comprise at least one of: deactivating the secondary uplink on the second cell, disabling the scheduling of the secondary uplink on the second cell, or switching a transmitting of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus (e.g., apparatus 1300 of FIG. 13). For example, the communication and processing circuitry 1641, as shown and described in connection with FIG. 16, may provide a means for deactivating the secondary uplink on the second cell, disabling the scheduling of the secondary uplink on the second cell, or switching a transmitting of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus.

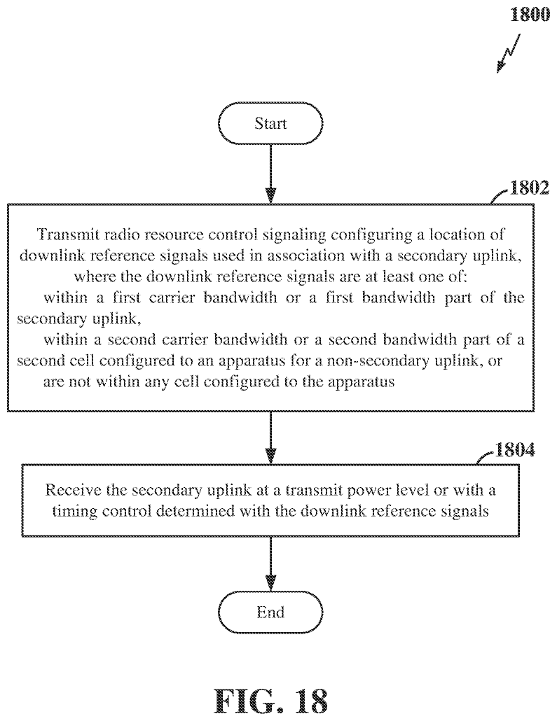

FIG. 18 is a flow chart illustrating an example process 1800 (e.g., a method) of wireless communication at a network entity (e.g., a base station, an aggregated or disaggregated base station, a gNB, a TRP, a scheduling entity) according to some aspects of the disclosure. As described below, some or all illustrated features may be omitted in a particular implementation within the scope of the present disclosure, and some illustrated features may not be required for implementation of all embodiments. In some examples, the process 1800 may be carried out by the network entity 1600, as illustrated and described in connection with FIG. 16. The network entity 1600 may be similar to, for example, any of the network entities (e.g., base stations, aggregated or disaggregated base stations, gNBs, TRPs, scheduling entities) of FIGS. 1-3, 5-12, and/or 16. In some examples, the process 1800 may be carried out by any suitable apparatus or means for carrying out the functions or algorithm described below.

At block 1802, the network entity may transmit radio resource control signaling configuring a location of downlink reference signals used in association with a secondary uplink. The downlink reference signals may be at least one of: within a first carrier bandwidth or a first bandwidth part of the secondary uplink, within a second carrier bandwidth or a second bandwidth part of a second cell configured to an apparatus (e.g., 1300 of FIG. 13) for a non-secondary uplink, or are not within any cell configured to the apparatus. For example, the downlink reference signal circuitry 1643, as shown and described in connection with FIG. 16, may provide a means for transmitting radio resource control signaling configuring a location of downlink reference signals used in association with a secondary uplink (where the downlink reference signals may be at least one of: within a first carrier bandwidth or a first bandwidth part of the secondary uplink, within a second carrier bandwidth or a second bandwidth part of a second cell configured to an apparatus for a non-secondary uplink, or are not within any cell configured to the apparatus). According to some aspects, the secondary uplink on the second cell, and a given uplink on the first cell belong to a same timing advance group (TAG).

In some examples, the downlink reference signals are at least one of: a synchronization signal/physical broadcast channel block (SSB), or a channel state information-reference signal (CSI-RS). In some examples, a radio resource control configuration for the downlink reference signals is provided under at least one of: a secondary uplink cell configuration, or a secondary uplink measurement configuration. In still other examples, the downlink reference signals are: periodic in IDLE mode, and periodic, semi-persistent, or aperiodic in CONNECTED mode.

In still other examples, in response to the downlink reference signals associated with the secondary uplink being non-cell defining synchronization signal/physical broadcast channel blocks (NCD-SSBs), the process 1800 may further comprise: transmitting cell defining-SSBs (CD-SSBs) in a cell scheduling the secondary uplink; and transmitting the NCD-SSBs in a configured frequency or carrier location associated with the secondary uplink. For example, the communication and processing circuitry 1641, as shown and described in connection with FIG. 16, may provide a means for transmitting cell defining-SSBs (CD-SSBs) in a cell scheduling the secondary uplink; and transmitting the NCD-SSBs in a configured frequency or carrier location associated with the secondary uplink in response to the downlink reference signals associated with the secondary uplink being non-cell defining synchronization signal/physical broadcast channel blocks (NCD-SSBs). According to some aspects, the NCD-SSBs may be configured within a third bandwidth or within a third bandwidth part of the cell scheduling the secondary uplink; and both the CD-SSBs and the NCD-SSBs may be within the third bandwidth or within the third bandwidth part of the cell scheduling the secondary uplink. According to some aspects, the NCD-SSBs may be configured by at least one of: radio resource control signaling in a CONNECTED mode, or system information broadcast (SIB) in an IDLE mode. In some examples, the process 1400 may include transmitting both CD-SSBs and NCD-SSBs in the cell scheduling the secondary uplink. In some examples, the process 1400 may include transmitting NCD-SSBs in association with processes related to the secondary uplink and transmitting CD-SSBs in association with processes related to the cell scheduling the secondary uplink.

At block 1804, the network entity may receive the secondary uplink at a transmit power level or with a timing control determined with the downlink reference signals. For example, the secondary uplink (eSUL) circuitry 1644, as shown and described in connection with FIG. 16, may provide a means for receiving the secondary uplink at a transmit power level or with a timing control determined with the downlink reference signals. According to some aspects, the secondary uplink has no associated downlink within a cell carrying the secondary uplink.

In some examples, the process 1800 may include using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink. For example, the communication and processing circuitry 1641, as shown and described in connection with FIG. 16, may provide a means for using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink.

In some examples, the process 1800 may include executing a mobility determination associated with the secondary uplink. According to some aspects, the mobility determination corresponds to at least one of: a cell-change, a cell-switch, a beam-change, or a beam-switch. For example, the communication and processing circuitry 1641, as shown and described in connection with FIG. 16, may provide a means for executing a mobility determination associated with the secondary uplink.

In some examples, the process 1800 may include transmitting the downlink reference signals associated with the secondary uplink in response to an activation of the secondary uplink; and ceasing the transmitting of the downlink reference signals associated with the secondary uplink in response to a deactivation of the secondary uplink. For example, the downlink reference signal circuitry 1643, as shown and described in connection with FIG. 16, may provide a means for transmitting the downlink reference signals associated with the secondary uplink in response to an activation of the secondary uplink; and ceasing the transmitting of the downlink reference signals associated with the secondary uplink in response to a deactivation of the secondary uplink.

Of course, in the above examples, the circuitry included in the processor 1304 of FIG. 13 and/or the processor 1604 of FIG. 16 is merely provided as an example. Other means for carrying out the described processes or functions may be included within various aspects of the present disclosure, including but not limited to the instructions stored in the computer-readable medium 1306 of FIG. 13 and/or the computer-readable medium 1606 of FIG. 16 or any other suitable apparatus or means described in any one of the FIGS. 1-3, 5-13, and/or 16 utilizing, for example, the processes and/or algorithms described herein in relation to FIGS. 5-12, 14, 15, 17, and/or 18.

The following provides an overview of aspects of the present disclosure:

Aspect 1: A method at an apparatus, comprising: receiving, in a downlink on a first cell, scheduling information configured to schedule a secondary uplink on a second cell, different from the first cell; at least one of: receiving downlink reference signals on the first cell, or receiving radio resource control signaling configuring a third cell on which the downlink reference signals are received, the third cell being the same as or different from the first cell, and receiving the downlink reference signals on the third cell; and transmitting the secondary uplink on the second cell.

Aspect 2: The method of aspect 1, wherein the secondary uplink has no associated downlink in the second cell.

Aspect 3: The method of aspect 1 or 2, further comprising: transmitting the secondary uplink on the second cell at a transmit power level or with a timing control determined with the downlink reference signals received on the at least one of: the first cell in response to receiving the downlink reference signals on the first cell, or the third cell in response to receiving the radio resource control signaling configuring the third cell.

Aspect 4: The method of any of aspects 1 through 3, further comprising: using the downlink reference signals in connection with at least one of: layer 3 radio resource management (L3 RRM), layer 1 beam management/inter-cell beam management (L1 BM/ICBM), determining a transmit power level, or determining a timing control, in association with the secondary uplink on the second cell and another uplink on at least one of: the first cell, or the third cell.

Aspect 5: The method of any of aspects 1 through 4, further comprising: independently executing mobility determinations for the secondary uplink on the second cell and another uplink on at least one of: the first cell, or the third cell.

Aspect 6: The method of aspect 5, where the mobility determinations correspond to at least one of: a cell-change, a cell-switch, a beam-change, or a beam-switch.

Aspect 7: The method of any of aspects 1 through 6, wherein the secondary uplink on the second cell, and another uplink on at least one of: the first cell, or the third cell belong to a same timing advance group (TAG).

Aspect 8: The method of any of aspects 1 through 7, wherein upon deactivation of the at least one of: the first cell, or the third cell, respectively, the method further comprises at least one of: deactivating the secondary uplink on the second cell, disabling the scheduling of the secondary uplink on the second cell, or switching a monitoring of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus.

Aspect 9: An apparatus, comprising: one or more memories; and one or more processors being configured to, individually or collectively, based at least in part on information stored in the one or more memories: receive, in a downlink on a first cell, scheduling information configured to schedule a secondary uplink on a second cell, different from the first cell; at least one of: receive downlink reference signals on the first cell, or receive radio resource control signaling configuring a third cell on which the downlink reference signals are received, the third cell being the same as or different from the first cell, and receive the downlink reference signals on the third cell; and transmit the secondary uplink on the second cell.

Aspect 10: The apparatus of aspect 9, wherein the secondary uplink has no associated downlink in the second cell.

Aspect 11: The apparatus of aspect 9 or 10, wherein the one or more processors are further configured to: transmit the secondary uplink on the second cell at a transmit power level or with a timing control determined with the downlink reference signals received on the at least one of: the first cell in response to receiving the downlink reference signals on the first cell, or the third cell in response to receiving the radio resource control signaling configuring the third cell.

Aspect 12: The apparatus of any of aspects 9 through 11, wherein the one or more processors are further configured to: use the downlink reference signals in connection with at least one of: layer 3 radio resource management (L3 RRM), layer 1 beam management/inter-cell beam management (L1 BM/ICBM), determining a transmit power level, or determining a timing control, in association with the secondary uplink on the second cell and another uplink on at least one of: the first cell, or the third cell.

Aspect 13: The apparatus of any of aspects 9 through 12, wherein the one or more processors are further configured to: independently execute mobility determinations for the secondary uplink on the second cell and another uplink on at least one of: the first cell, or the third cell.

Aspect 14: The apparatus of aspect 13, where the mobility determinations correspond to at least one of: a cell-change, a cell-switch, a beam-change, or a beam-switch.

Aspect 15: The apparatus of any of aspects 9 through 14, wherein the secondary uplink on the second cell, and another uplink on at least one of: the first cell, or the third cell belong to a same timing advance group (TAG).

Aspect 16: The apparatus of any of aspects 9 through 15, wherein upon deactivation of the at least one of: the first cell, or the third cell, respectively, the one or more processors are further configured to at least one of: deactivate the secondary uplink on the second cell, disable the scheduling of the secondary uplink on the second cell, or switch a monitoring of the downlink reference signals from the second cell in association with the secondary uplink to at least one of: a cell within a band, a band set, or a frequency range (FR) where the secondary uplink is configured, a cell within a timing advance group (TAG) where the secondary uplink is configured, a cell based on a cell index, or a cell based on a rule established by an implementation of the apparatus.

Aspect 17: A method at an apparatus, comprising: receiving radio resource control signaling configuring a location of downlink reference signals used in association with a secondary uplink, wherein the downlink reference signals are at least one of: within a first carrier bandwidth or a first bandwidth part of the secondary uplink, within a second carrier bandwidth or a second bandwidth part of a second cell configured to the apparatus for a non-secondary uplink, or are not within any cell configured to the apparatus; and transmitting the secondary uplink at a transmit power level or with a timing control determined with the downlink reference signals.

Aspect 18: The method of aspect 17, wherein the secondary uplink has no associated downlink within a cell carrying the secondary uplink.

Aspect 19: The method of aspect 17 or 18, further comprising: using the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink.

Aspect 20: The method of any of aspects 17 through 19, further comprising: executing a mobility determination associated with the secondary uplink.

Aspect 21: The method of any of aspects 17 through 20, further comprising: monitoring the downlink reference signals associated with the secondary uplink in response to an activation of the secondary uplink; and ceasing the monitoring of the downlink reference signals associated with the secondary uplink in response to a deactivation of the secondary uplink.

Aspect 22: The method of any of aspects 17 through 21, wherein in response to the downlink reference signals associated with the secondary uplink being non-cell defining synchronization signal/physical broadcast channel blocks (NCD-SSBs), the method further comprises: monitoring cell defining-SSBs (CD-SSBs) in a cell scheduling the secondary uplink; and monitoring the NCD-SSBs in a configured frequency or carrier location associated with the secondary uplink.

Aspect 23: The method of aspect 22, wherein the apparatus monitors both CD-SSBs and NCD-SSBs in the cell scheduling the secondary uplink.

Aspect 24: The method of aspect 22, wherein the apparatus monitors NCD-SSBs in association with processes related to the secondary uplink and monitors CD-SSBs in association with processes related to the cell scheduling the secondary uplink.

Aspect 25: An apparatus, comprising: one or more memories; and one or more processors being configured to, individually or collectively, based at least in part on information stored in the one or more memories: receive radio resource control signaling configuring a location of downlink reference signals used in association with a secondary uplink, wherein the downlink reference signals are at least one of: within a first carrier bandwidth or a first bandwidth part of the secondary uplink, within a second carrier bandwidth or a second bandwidth part of a second cell configured to the apparatus for a non-secondary uplink, or are not within any cell configured to the apparatus; and transmit the secondary uplink at a transmit power level or with a timing control determined with the downlink reference signals.

Aspect 26: The apparatus of aspect 25, wherein the secondary uplink has no associated downlink within a cell carrying the secondary uplink.

Aspect 27: The apparatus of aspect 25 or 26, wherein the one or more processors are further configured to: use the downlink reference signals in connection with at least one of: layer 3 radio resource management (L3 RRM), layer 1 beam management/inter-cell beam management (L1 BM/ICBM), determining the transmit power level, or determining the timing control, in association with the secondary uplink.

Aspect 28: The apparatus of any of aspects 25 through 27, wherein the one or more processors are further configured to: execute a mobility determination associated with the secondary uplink.

Aspect 29: The apparatus of any of aspects 25 through 28, wherein the one or more processors are further configured to: monitor the downlink reference signals associated with the secondary uplink in response to an activation of the secondary uplink; and cease to monitor the downlink reference signals associated with the secondary uplink in response to a deactivation of the secondary uplink.

Aspect 30: The apparatus of any of aspects 25 through 29, wherein in response to the downlink reference signals associated with the secondary uplink being non-cell defining synchronization signal/physical broadcast channel blocks (NCD-SSBs), the one or more processors are further configured to: monitor cell defining-SSBs (CD-SSBs) in a cell scheduling the secondary uplink; and monitor the NCD-SSBs in a configured frequency or carrier location associated with the secondary uplink.

Aspect 31: An apparatus configured for wireless communication comprising at least one means for performing a method of any one of aspects 1 through 8 or 17 through 24.

Aspect 32: A non-transitory computer-readable medium storing computer-executable code, comprising code for causing an apparatus to perform a method of any one of aspects 1 through 8 or 17 through 24.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features, and/or functions illustrated in FIGS. 1-18 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-18 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing, and other similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Similarly, a phrase referring to A and/or B may include A only. B only, or a combination of A and B.

As used herein, “based on” is intended to be interpreted in the inclusive sense, unless otherwise explicitly indicated. For example, “based on” may be used interchangeably with “based at least in part on.” “associated with,” or “in accordance with” unless otherwise explicitly indicated. Specifically, unless a phrase refers to “based on only ‘a,’” or the equivalent in context, whatever it is that is “based on ‘a,2” or “based at least in part on ‘a.’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method at an apparatus, comprising:
receiving, in a downlink on a first cell, scheduling information configured to schedule a secondary uplink on a second cell, different from the first cell;
at least one of:
receiving downlink reference signals on the first cell, or
receiving radio resource control signaling configuring a third cell on which the downlink reference signals are received, the third cell being the same as or different from the first cell, and
receiving the downlink reference signals on the third cell; and
transmitting the secondary uplink on the second cell.

2. The method of claim 1, wherein the secondary uplink has no associated downlink in the second cell.

3. The method of claim 1, further comprising:
transmitting the secondary uplink on the second cell at a transmit power level or with a timing control determined with the downlink reference signals received on the at least one of:
the first cell in response to receiving the downlink reference signals on the first cell, or
the third cell in response to receiving the radio resource control signaling configuring the third cell.

4. The method of claim 1, further comprising:
using the downlink reference signals in connection with at least one of:
layer 3 radio resource management (L3 RRM),
layer 1 beam management/inter-cell beam management (L1 BM/ICBM),
determining a transmit power level, or
determining a timing control,
in association with the secondary uplink on the second cell and another uplink on at least one of: the first cell, or the third cell.

5. The method of claim 1, further comprising:
independently executing mobility determinations for the secondary uplink on the second cell and another uplink on at least one of: the first cell, or the third cell.

6. The method of claim 5, where the mobility determinations correspond to at least one of:
a cell-change,
a cell-switch,
a beam-change, or
a beam-switch.

7. The method of claim 1, wherein
the secondary uplink on the second cell, and
another uplink on at least one of: the first cell, or the third cell belong to a same timing advance group (TAG).

8. The method of claim 1, wherein upon deactivation of the at least one of:
the first cell, or
the third cell, respectively, the method further comprises at least one of:
deactivating the secondary uplink on the second cell,
disabling the scheduling of the secondary uplink on the second cell, or
switching a monitoring of the downlink reference signals from the second cell in association with the secondary uplink to at least one of:
a cell within a band, a band set, or a frequency range (FR) where the secondary uplink is configured,
a cell within a timing advance group (TAG) where the secondary uplink is configured,
a cell based on a cell index, or
a cell based on a rule established by an implementation of the apparatus.

9. An apparatus, comprising:
one or more memories; and
one or more processors being configured to, individually or collectively, based at least in part on information stored in the one or more memories:
receive, in a downlink on a first cell, scheduling information configured to schedule a secondary uplink on a second cell, different from the first cell;
at least one of:
receive downlink reference signals on the first cell, or
receive radio resource control signaling configuring a third cell on which the downlink reference signals are received, the third cell being the same as or different from the first cell, and
receive the downlink reference signals on the third cell; and
transmit the secondary uplink on the second cell.

10. The apparatus of claim 9, wherein the secondary uplink has no associated downlink in the second cell.

11. The apparatus of claim 9, wherein the one or more processors are further configured to:
transmit the secondary uplink on the second cell at a transmit power level or with a timing control determined with the downlink reference signals received on the at least one of:
the first cell in response to receiving the downlink reference signals on the first cell, or
the third cell in response to receiving the radio resource control signaling configuring the third cell.

12. The apparatus of claim 9, wherein the one or more processors are further configured to:
use the downlink reference signals in connection with at least one of:
layer 3 radio resource management (L3 RRM),
layer 1 beam management/inter-cell beam management (L1 BM/ICBM),
determining a transmit power level, or
determining a timing control,
in association with the secondary uplink on the second cell and another uplink on at least one of: the first cell, or the third cell.

13. The apparatus of claim 9, wherein the one or more processors are further configured to:
independently execute mobility determinations for the secondary uplink on the second cell and another uplink on at least one of: the first cell, or the third cell.

14. The apparatus of claim 13, where the mobility determinations correspond to at least one of:
a cell-change,
a cell-switch,
a beam-change, or
a beam-switch.

15. The apparatus of claim 9, wherein
the secondary uplink on the second cell, and
another uplink on at least one of: the first cell, or the third cell belong to a same timing advance group (TAG).

16. The apparatus of claim 9, wherein upon deactivation of the at least one of:
the first cell, or
the third cell, respectively, the one or more processors are further configured to at least one of:
deactivate the secondary uplink on the second cell,
disable the scheduling of the secondary uplink on the second cell, or
switch a monitoring of the downlink reference signals from the second cell in association with the secondary uplink to at least one of:
a cell within a band, a band set, or a frequency range (FR) where the secondary uplink is configured,
a cell within a timing advance group (TAG) where the secondary uplink is configured,
a cell based on a cell index, or
a cell based on a rule established by an implementation of the apparatus.

17. A method at an apparatus, comprising:
receiving radio resource control signaling configuring a location of downlink reference signals used in association with a secondary uplink, wherein the downlink reference signals are at least one of:
within a first carrier bandwidth or a first bandwidth part of the secondary uplink,
within a second carrier bandwidth or a second bandwidth part of a second cell configured to the apparatus for a non-secondary uplink, or
are not within any cell configured to the apparatus; and
transmitting the secondary uplink at a transmit power level or with a timing control determined with the downlink reference signals.

18. The method of claim 17, wherein the secondary uplink has no associated downlink within a cell carrying the secondary uplink.

19. The method of claim 17, further comprising:
using the downlink reference signals in connection with at least one of:
layer 3 radio resource management (L3 RRM),
layer 1 beam management/inter-cell beam management (L1 BM/ICBM),
determining the transmit power level, or
determining the timing control,
in association with the secondary uplink.

20. The method of claim 17, further comprising:
executing a mobility determination associated with the secondary uplink.

21. The method of claim 17, further comprising:
monitoring the downlink reference signals associated with the secondary uplink in response to an activation of the secondary uplink; and
ceasing the monitoring of the downlink reference signals associated with the secondary uplink in response to a deactivation of the secondary uplink.

22. The method of claim 17, wherein in response to the downlink reference signals associated with the secondary uplink being non-cell defining synchronization signal/physical broadcast channel blocks (NCD-SSBs), the method further comprises:
monitoring cell defining-SSBs (CD-SSBs) in a cell scheduling the secondary uplink; and
monitoring the NCD-SSBs in a configured frequency or carrier location associated with the secondary uplink.

23. The method of claim 22, wherein the apparatus monitors both CD-SSBs and NCD-SSBs in the cell scheduling the secondary uplink.

24. The method of claim 22, wherein the apparatus monitors NCD-SSBs in association with processes related to the secondary uplink and monitors CD-SSBs in association with processes related to the cell scheduling the secondary uplink.

25. An apparatus, comprising:
one or more memories; and
one or more processors being configured to, individually or collectively, based at least in part on information stored in the one or more memories:
receive radio resource control signaling configuring a location of downlink reference signals used in association with a secondary uplink, wherein the downlink reference signals are at least one of:
within a first carrier bandwidth or a first bandwidth part of the secondary uplink,
within a second carrier bandwidth or a second bandwidth part of a second cell configured to the apparatus for a non-secondary uplink, or
are not within any cell configured to the apparatus; and
transmit the secondary uplink at a transmit power level or with a timing control determined with the downlink reference signals.

26. The apparatus of claim 25, wherein the secondary uplink has no associated downlink within a cell carrying the secondary uplink.

27. The apparatus of claim 25, wherein the one or more processors are further configured to:
use the downlink reference signals in connection with at least one of:
layer 3 radio resource management (L3 RRM),
layer 1 beam management/inter-cell beam management (L1 BM/ICBM),
determining the transmit power level, or
determining the timing control,
in association with the secondary uplink.

28. The apparatus of claim 25, wherein the one or more processors are further configured to:
execute a mobility determination associated with the secondary uplink.

29. The apparatus of claim 25, wherein the one or more processors are further configured to:
monitor the downlink reference signals associated with the secondary uplink in response to an activation of the secondary uplink; and
cease to monitor the downlink reference signals associated with the secondary uplink in response to a deactivation of the secondary uplink.

30. The apparatus of claim 25, wherein in response to the downlink reference signals associated with the secondary uplink being non-cell defining synchronization signal/physical broadcast channel blocks (NCD-SSBs), the one or more processors are further configured to:
monitor cell defining-SSBs (CD-SSBs) in a cell scheduling the secondary uplink; and
monitor the NCD-SSBs in a configured frequency or carrier location associated with the secondary uplink.
